(19) United States
(12) Patent Application Publication
(10) Pub. No.: US 2010/0070395 A1
(43) Pub. Date: Mar. 18, 2010

(54) ARCHITECTURAL DESIGN FOR PAYROLL PROCESSING APPLICATION SOFTWARE

(76) Inventors: Andreas Elkeles, Foster City, CA (US); Fabian Guenther, Mauer (DE); Philipp Suenderhauf, Leimen (DE); Andreas Bold, Ludwigshafen (DE); Peter Latocha, Malsch (DE); Bernhard Drittler, Walldorf (DE); Joerg Heitmann, Walldorf (DE)

Correspondence Address: FISH & RICHARDSON, P.C., PO BOX 1022, MINNEAPOLIS, MN, 55440-1022, US

(21) Appl. No.: 12/233,557

(22) Filed: Sep. 18, 2008

(51) Int. Cl. G06Q 10/00

(52) U.S. Cl. 705/32

(57) ABSTRACT

Methods, systems, and apparatuses, including computer program products, for implementing a software architecture design for a software application implementing payroll processing. The application is structured as multiple process components interacting with each other through service interfaces, and multiple service operations, each being implemented for a respective process component. The process components include a Payroll Processing process component, an Employee Payroll Administration process component, an Accounting process component, and a Payroll Processing at Provider process component.

### BACKGROUND

The subject matter of this patent application relates to computer software architecture and, more particularly, to the architecture of application software for payroll processing.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a software application implementing payroll processing.

In its various aspects, the software architecture design can be implemented as methods, systems, and apparatuses, including computer program products, for implementing a software architecture design for a software application implementing payroll processing. The software application is structured as multiple process components interacting with each other through service interfaces, and multiple service operations, each being implemented for a respective process component. The process components include a Payroll Processing process component, an Employee Payroll Administration process component, an Accounting process component, and a Payroll Processing at Provider process component.

In its various aspects, the software architecture design can further be implemented as methods, systems, and apparatuses, including computer program products, implementing a software architecture design for a software application that is adapted to interact with external software systems through the service operations described in reference to external process components, or a subcombination of them.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a payroll processing software application.

FIG. 2 illustrates the elements of the architecture as they are drawn in the figures.

FIG. 3 is a block diagram showing interactions between a Payroll Processing process component and a Payroll Processing at Provider process component related to employee payroll input in Canada.

FIG. 4 is a block diagram showing interactions between the Payroll Processing process component and the Payroll Processing at Provider process component related to employee payroll input in the United States.

FIG. 5 is a block diagram showing interactions between the Payroll Processing process component and the Payroll Processing at Provider process component related to employee payroll input in Great Britain.

FIG. 6 is a block diagram showing interactions between the Payroll Processing process component and the Payroll Processing at Provider process component related to employee payroll input in France.

FIG. 7 is a block diagram showing interactions between the Payroll Processing process component and an Accounting process component.

FIG. 8 is a block diagram showing interactions between the Payroll Processing process component and the Payroll Processing at Provider process component related to payroll processing and results.

FIG. 9 is a block diagram showing interactions between the Payroll Processing process component and the Payroll Processing at Provider process component related to employee payroll input in South Africa.

FIG. 10 is a block diagram showing interactions between the Payroll Processing process component and the Payroll Processing at Provider process component related to Germany employee payroll input in Germany.

FIG. 11 is a block diagram showing interactions between the Payroll Processing process component and the Payroll Processing at Provider process component related to employee payroll input in Denmark.

FIG. 12 is a block diagram showing interactions between the Payroll Processing process component and the Payroll Processing at Provider process component related to a payroll process.

FIG. 13 is a block diagram showing interactions between the Payroll Processing process component and the Payroll Processing at Provider process component related to employee payroll input in Singapore.

FIG. 14 is a block diagram showing interactions between the Payroll Processing process component and the Payroll Processing at Provider process component related to employee payroll input in the Netherlands.

FIG. 15 is a block diagram showing interactions between the Payroll Processing process component and the Payroll Processing at Provider process component related to employee payroll input in China.

FIG. 16 is a block diagram showing interactions between the Payroll Processing process component and the Payroll Processing at Provider process component related to employee payroll input in Australia.

FIG. 17 is a block diagram showing interactions between the Payroll Processing at Provider process component and the Payroll Processing process component.

FIG. 18 is a block diagram showing interactions between the Payroll Processing process component and the Payroll Processing at Provider process component related to employee payroll input in Italy.

FIG. 19 is a block diagram showing interactions between the Payroll Processing process component and an Employee Payroll Administration process component.

### DETAILED DESCRIPTION

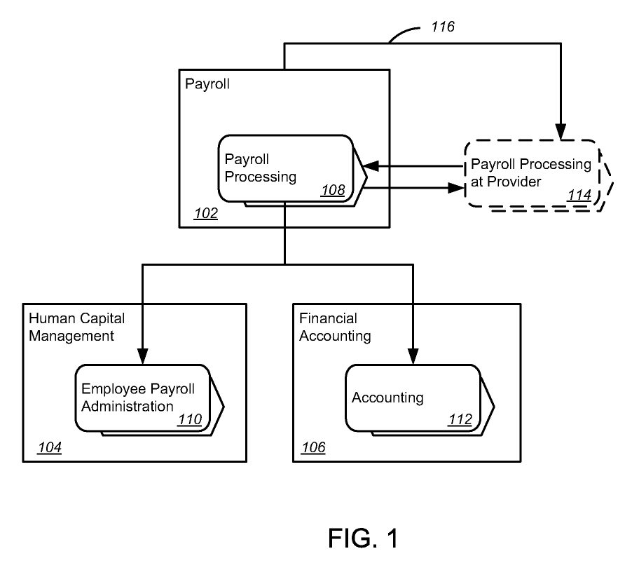

FIG. 1 shows the software architectural design for a payroll processing software application. As shown in FIG. 1, the payroll processing design includes a Payroll deployment unit 102, a Human Capital Management deployment unit 104, and a Financial Accounting deployment unit 106.

The Payroll deployment unit 102 includes a Payroll Processing process component 108 that handles the execution and monitoring of regular as well as off-cycle payroll processes. This includes completeness checks of payroll relevant employee data, the payroll run itself, verification of the results and the transfer to financial accounting.

The Human Capital Management deployment unit 104 includes an Employee Payroll Administration process component 110 that handles the administration of the employee specific payroll agreement and the overview of completed and planned payroll processes.

The Financial Accounting deployment unit 106 includes an Accounting process component 112 that represents relevant business transactions for valuation and profitability analysis.

A number of external process components, described below, will be used to describe the architectural design. These include a Payroll Processing at Provider process component 114. The Payroll Processing at Provider process component 114 handles the execution and monitoring of regular as well as off-cycle payroll processes. This includes completeness checks of payroll relevant employee data, the payroll run itself, verification of the results and the transfer to financial accounting.

FIG. 1 includes an arrow 116 that represents various payroll input replication interactions occurring between the Payroll Processing process component 108 and the Payroll processing at Provider process component 114. The replication interactions can relate to an Italy employee payroll input, a South Africa employee payroll input, a Germany employee payroll input, a Denmark employee payroll input, a Singapore employee payroll input, a Netherlands employee payroll input, a China employee payroll input, an Australia employee payroll input, a Canada employee payroll input, a United States employee payroll input, a Great Britain employee payroll input, or a France employee payroll input.

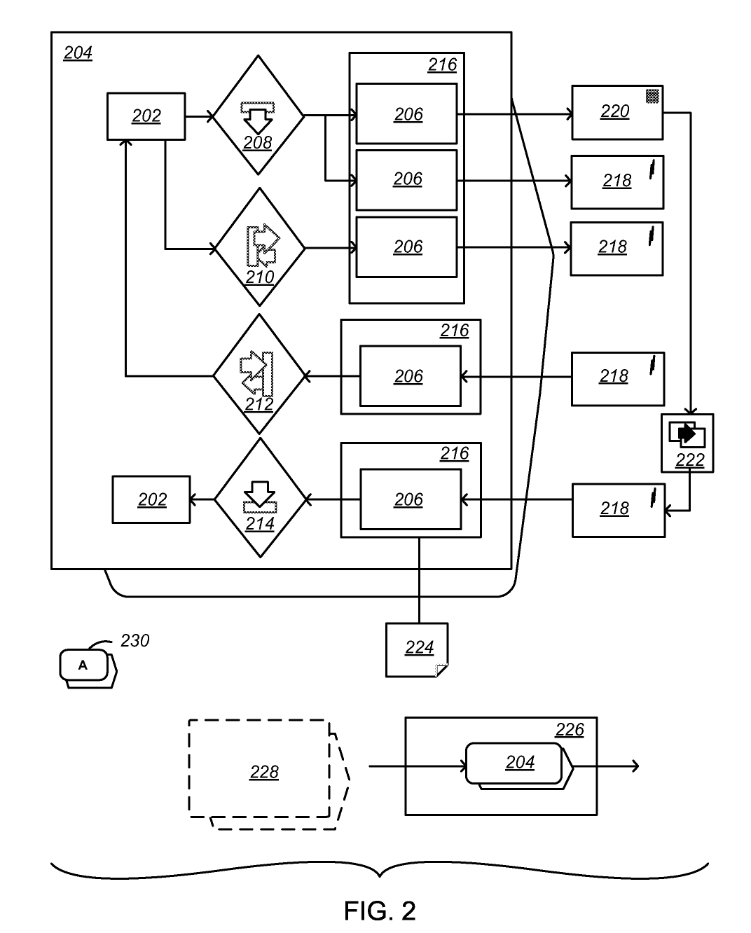

FIG. 2 illustrates the elements of the architecture as they are drawn in the figures of this patent application. The elements of the architecture include the business object 202, the process component 204, the operation 206, the outbound process agent 208, the synchronous outbound process agent 210, the synchronous inbound process agent 212, the inbound process agent 214, the service interface or interface 216, the message 218, the form message 220, the mapping entity 222, the communication channel template 224, and the deployment unit 226.

Not explicitly represented in the figures is a foundation layer that contains all fundamental entities that are used in multiple deployment units 226. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

A process component of an external system is drawn as a dashed-line process component 228. Such a process component 228 represents the external system in describing interactions with the external system; however, the process component 228 need not represent more of the external system than is needed to produce and receive messages as required by the process component that interacts with the external system.

The connector icon 230 is used to simplify the drawing of interactions between process components 204. Interactions between process component pairs 204 involving their respective business objects 202, process agents (at 208, 210, 212, and 214), operations 206, interfaces 216, and messages (at 218 and 22) are described as process component interactions, which determine the interactions of a pair of process components across a deployment unit boundary, i.e., from one deployment unit 226 to another deployment unit 226. Interactions between process components 204 are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components 204, but interfaces 216, process agents (at 208, 210, 212, and 214), and business objects 202 that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component 204 is described as being contained in a deployment unit 226. It should be understood, however, that such operational inclusion can be realized in a variety of ways and is not limited to a physical inclusion of the entirety of one element in another.

The architectural elements include the business object 202. A business object 202 is a representation of a type of a uniquely identifiable business entity (an object instance) described by a structural model. Processes operate on business objects. This example business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component 204, is an object that encapsulates transactional data (i.e., data that is valid for a point in time). The term business object will be used generically to refer to a business process object and a master data object, unless the context requires otherwise. Properly implemented, business objects 202 are implemented free of redundancies.

The architectural elements also include the process component 204. A process component 204 is a software package that realizes a business process and generally exposes its functionality as services. The functionality includes the ability to perform all or parts of particular kinds of business transactions. A process component 204 contains one or more semantically related business objects 202. Any business object belongs to no more than one process component. Process components can be categorized as a standard process component, a process component at a business partner, a third party process component, or a user centric process component. The standard process component (named simply process component) is a software package that realizes a business process and exposes its functionality as services. The process component at a business partner is a placeholder for a process component (or other technology that performs the essential functions of the process component) used at a business partner. The third party process component is a process component (or other technology that performs the essential functions of the process component) provided by a third party. The user centric process component is a process component containing user interface parts.

Process components 204 are modular and context-independent. That they are context-independent means that a process component 204 is not specific to any specific application and is reusable. The process component 204 is often the smallest (most granular) element of reuse in the architecture.

The architectural elements also include the operation 206. An operation 206 belongs to exactly one process component 204. A process component 204 generally is able to perform multiple operations 206. Operations 206 can be synchronous or asynchronous, corresponding to synchronous or asynchronous process agents (e.g. at 208, 210, 212, and 214), which will be described below. Operation 206 may be the smallest, separately-callable function, described by a set of data types used as input, output, and fault parameters serving as a signature.

The architectural elements also include the service interface 216, referred to simply as the interface. An interface 216 is a named group of operations 206. Interface 216 typically specifies inbound service interface functionality or outbound service interface functionality. Each operation 206 belongs to exactly one interface 216. An interface 216 belongs to exactly one process component 204. A process component 204 might contain multiple interfaces 216. In some implementations, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations 206 directed to the same other process component 204 are in one interface 216.

The architectural elements also include the message 218. Operations 206 transmit and receive messages 218. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component. In some implementations, the message is a form based message 220 that can be translated into a recognized format for an external process component 228. The form message type 220 is a message type used for documents structured in forms. The form message type 220 can be used for printing, faxing, emailing, or other events using documents structured in forms. In some implementations, the form message type 220 provides an extended signature relative to the normal message type. For example, the form message type 220 can include text information in addition to identification information to improve human reading.

The architectural elements also include the process agent (e.g. at 208, 210, 212, and 214). Process agents do business processing that involves the sending or receiving of messages 218. Each operation 206 will generally have at least one associated process agent.

The process agent can be associated with one or more operations 206. Process agents (at 208, 210, 212, and 214) can be either inbound or outbound, and either synchronous or asynchronous.

Asynchronous outbound process agents 208 are called after a business object 202 changes, e.g., after a create, update, or delete of a business object instance. Synchronous outbound process agents 210 are generally triggered directly by a business object 202.

An outbound process agent (208 and 210) will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents (212 and 214) are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents (210 and 212) are used when a process component requires a more or less immediate response from another process component, and is waiting for that response to continue its work.

Operations and process components are described in this specification in terms of process agents. However, in alternative implementations, process components and operations can be implemented without use of agents by using other conventional techniques to perform the functions described in this specification.

The architectural elements also include the communication channel template. The communication channel template is a modeling entity that represents a set of technical settings used for communication. The technical settings can include details for inbound or outbound processing of a message. The details can be defined in the communication channel template. In particular, the communication channel template defines an adapter type, a transport protocol, and a message protocol. In some implementations, various other parameters may be defined based on a selected adapter type. For example, the communication channel template can define a security level, conversion parameters, default exchange infrastructure parameters, processing parameters, download URI parameters, and specific message properties.

The communication channel template 224 can interact with internal or external process components (at 204 and 228). To interact with an internal process component, the communication channel template is received and uploaded to be used with an operation and interface pair. To interact with an external process component, the communication channel template is received and uploaded to be used with an external entity, such as an external bank, business partner, or supplier.

The architectural elements also include the deployment unit 226. A deployment unit 226 includes one or more process components 204 that are deployed together on a single computer system platform. Conversely, separate deployment units can be deployed on separate physical computing systems. For this reason, a boundary of a deployment unit 226 defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components 204 of one instance of one deployment unit 226.

The process components 204 of one deployment unit 226 interact with those of another deployment unit 226 using messages 218 passed through one or more data communication networks or other suitable communication channels. Thus, a deployment unit 226 deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units 226 is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components 204 that interact with other process components 204 or external systems only through messages 218, e.g., as sent and received by operations 206, can also be replaced as long as the replacement supports the operations 206 of the original 204.

In contrast to a deployment unit 226, the foundation layer does not define a limit for application-defined transactions. Deployment units 226 communicate directly with entities in the foundation layer, which communication is typically not message based. The foundation layer is active in every system instance on which the application is deployed. Business objects 202 in the foundation layer will generally be master data objects. In addition, the foundation layer will include some business process objects that are used by multiple deployment units 226. Master data objects and business process objects that should be specific to a deployment unit 226 are assigned to their respective deployment unit 226.

Interactions between Process Components “Payroll Processing” and “Payroll Processing at Provider”

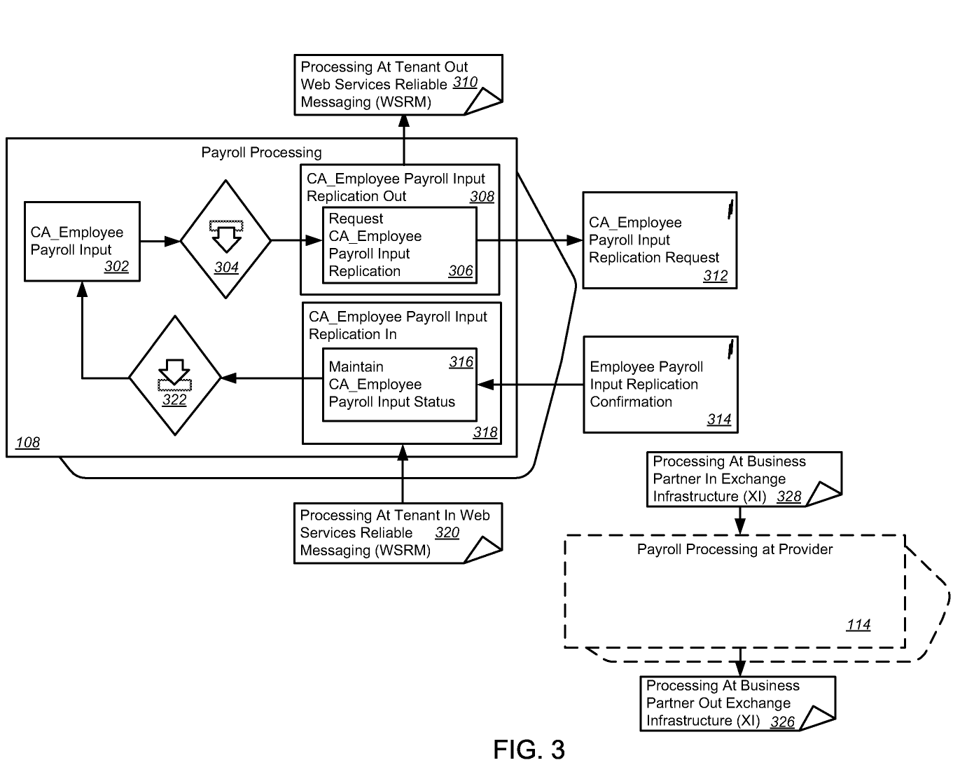

FIG. 3 is a block diagram showing interactions between the Payroll Processing process component 108 and the Payroll Processing at Provider process component 114, related to employee payroll input in Canada (CA), in the architectural design of FIG. 1.

As shown in FIG. 3, the Payroll Processing process component 108 includes a CA_Employee Payroll Input business object 302. The CA_Employee Payroll Input business object 302 represents a summary of all employee-specific input for Canadian payroll for one employee. When a CA_Employee Payroll Input business object 302 has been created, changed, or cancelled, replication can be requested using a Request Replication from CA_Employee Payroll Input to Payroll Processing at Provider outbound process agent 304. The process agent 304 invokes a Request CA_Employee Payroll Input Replication operation 306 to request replication of the CA_Employee Payroll Input business object 302, for example, to the Payroll Processing at Provider process component 114. The operation 306 is included in a CA_Employee Payroll Input Replication Out interface 308. The Payroll Processing process component sends information to the Payroll Processing at Provider process component 114 using a Processing at Tenant Out Web Services Reliable Messaging (WSRM) communication channel template 310. The communication channel template 310 can define protocols and parameters used for communication with an external party.

The Request CA_Employee Payroll Input Replication operation 306 generates a CA_Employee Payroll Input Replication Request message 312. For example, the message 312 can be sent to the Payroll Processing at Provider process component 114.

The Payroll Processing at Provider process component 114 can send an Employee Payroll Input Replication Confirmation message 314 to the Payroll Processing process component 108. The message 314 is handled in a Maintain CA_Employee Payroll Input Status operation 316. The operation 316 maintains information on the status of the CA_Employee Payroll Input business object 302. The operation 316 is included in a CA_Employee Payroll Input Replication In interface 318. The Payroll Processing process component 108 receives information from the Payroll Processing at Provider process component 114 using a Processing at Tenant In Web Services Reliable Messaging (WSRM) communication channel template 320.

The Maintain CA_Employee Payroll Input Status operation 316 uses a Maintain CA_Employee Payroll Input Status based on Replication Confirmation inbound process agent 322 to update the CA_Employee Payroll Input business object 302.

The Payroll Processing at Provider process component 114 receives information from the Payroll Processing process component 108 using a Processing At Business Partner In Exchange Infrastructure (XI) communication channel template 328. The communication channel template 328 can define protocols and parameters used for communication with an external party. The Payroll Processing at Provider process component 114 sends information to the Payroll Processing process component 108 using a Processing At Business Partner Out Exchange Infrastructure (XI) communication channel template 326. The communication channel template 326 can define protocols and parameters used for communication with an external party. While XI represents Exchange Infrastructure, any similar or suitable third-party or proprietary tool may be used to perform the functions provided by or described in relation to XI.

Interactions between Process Components “Payroll Processing” and “Payroll Processing at Provider”

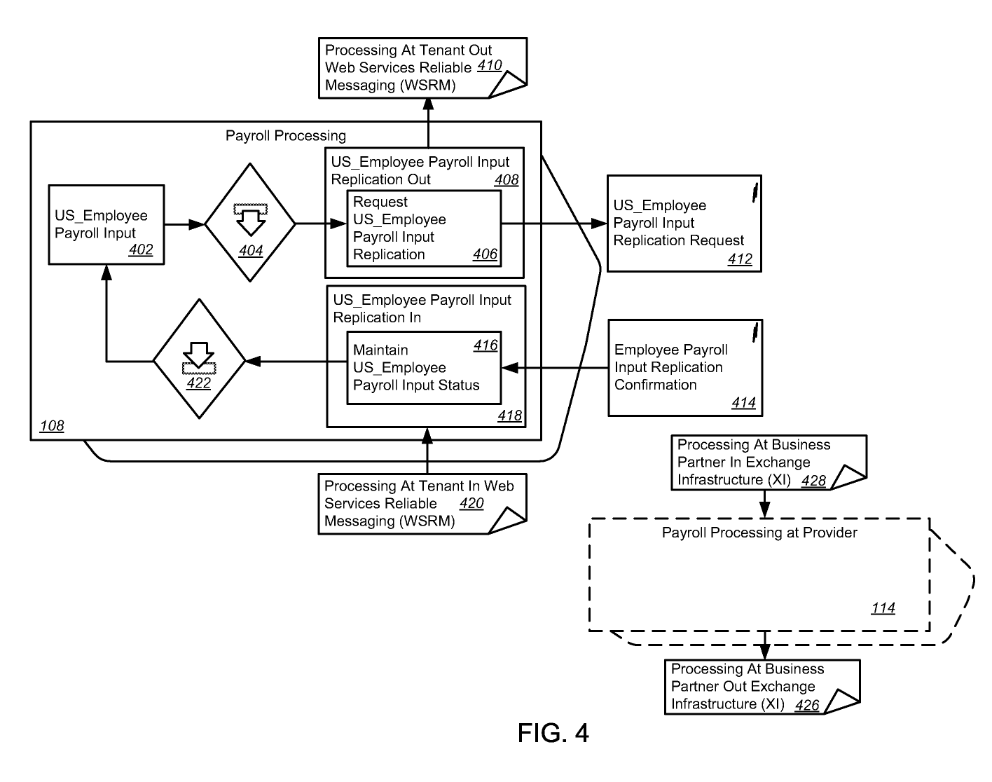

FIG. 4 is a block diagram showing interactions between the Payroll Processing process component 108 and the Payroll Processing at Provider process component 114, related to employee payroll input in the United States (US), in the architectural design of FIG. 1. As shown in FIG. 4, the Payroll Processing process component 108 includes a US_Employee Payroll Input business object 402. The US_Employee Payroll Input business object 402 represents a summary of all employee-specific input for American payroll for one employee. When a US_Employee Payroll Input business object 402 has been created, changed, or cancelled, replication can be requested using a Request Replication from US_Employee Payroll Input to Payroll Processing at Provider outbound process agent 404. The process agent 404 invokes a Request US_Employee Payroll Input Replication operation 406 to request replication of the US_Employee Payroll Input business object 402, for example, to the Payroll Processing at Provider process component 114. The operation 406 is included in a US_Employee Payroll Input Replication Out interface 408. The Payroll Processing process component 108 sends information to the Payroll Processing at Provider process component 114 using a Processing at Tenant Out Web Services Reliable Messaging (WSRM) communication channel template 410. The US_Employee Payroll Input Replication Out interface 408 sends information to the Payroll Processing at Provider processing component 114 using the Processing At Tenant Out Web Services Reliable Messaging (WSRM) communication channel template 410. The communication channel template 410 can define protocols and parameters used for communication with an external party.

The Request US_Employee Payroll Input Replication operation 406 generates an US_Employee Payroll Input Replication Request message 412. For example, the message 412 can be sent to the Payroll Processing at Provider process component 114.

The Payroll Processing at Provider process component 114 can send an Employee Payroll Input Replication Confirmation message 414 to the Payroll Processing process component 108. The message 414 is handled in a Maintain US_Employee Payroll Input Status operation 416. The operation 416 maintains information on the status of the US_Employee Payroll Input business object 402. The operation 416 is included in an US_Employee Payroll Input Replication In interface 418. The US_Employee Payroll Input Replication In interface 418 receives information from the Payroll Processing at Provider process component 114 using a Processing at Tenant In Web Services Reliable Messaging (WSRM) communication channel template 420.

The Maintain US_Employee Payroll Input Status operation 416 uses a Maintain US_Employee Payroll Input Status based on Replication Confirmation inbound process agent 422 to update the US_Employee Payroll Input business object 402.

The Payroll Processing at Provider process component 114 receives information from the Payroll Processing process component 108 using a Processing At Business Partner In Exchange Infrastructure (XI) communication channel template 428. The communication channel template 428 can define protocols and parameters used for communication with an external party. The Payroll Processing at Provider process component 114 sends information to the Payroll Processing process component 108 using a Processing At Business Partner Out Exchange Infrastructure (XI) communication channel template 426. The communication channel template 426 can define protocols and parameters used for communication with an external party.

Interactions between Process Components “Payroll Processing” and “Payroll Processing at Provider”

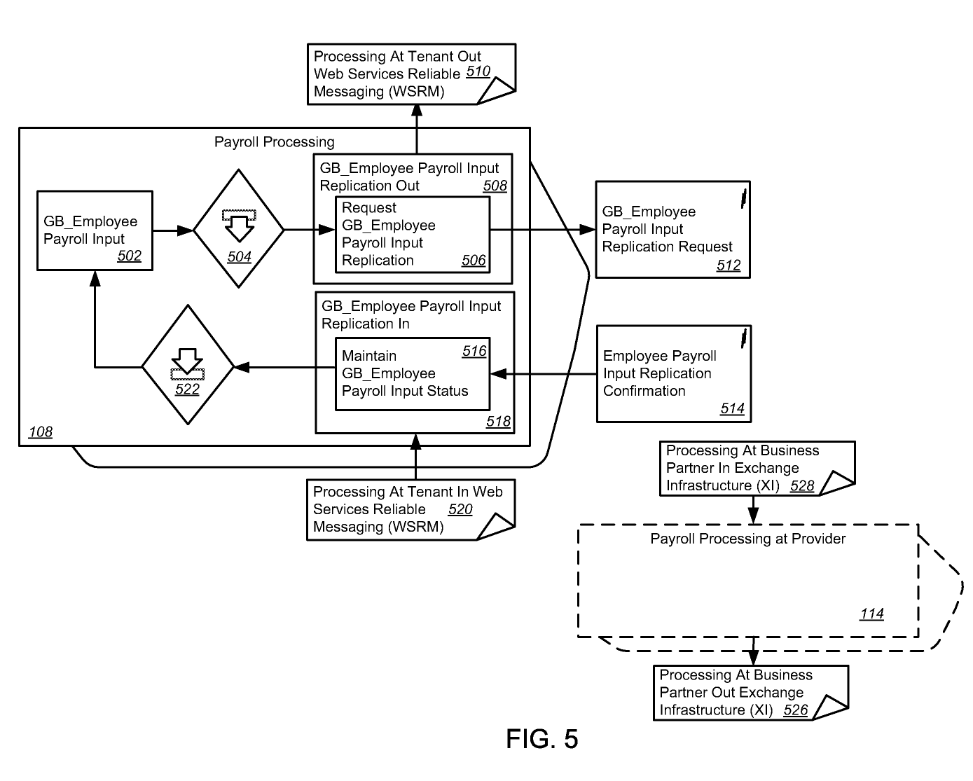

FIG. 5 is a block diagram showing interactions between the Payroll Processing process component 108 and the Payroll Processing at Provider process component 114, related to employee payroll input in Great Britain (GB), in the architectural design of FIG. 1. As shown in FIG. 5, the Payroll Processing process component 108 includes a GB_Employee Payroll Input business object 502. The GB_Employee Payroll Input business object 502 represents a summary of all employee-specific input for British payroll for one employee. When a GB_Employee Payroll Input business object 502 has been created, changed, or cancelled, replication can be requested using a Request Replication from GB_Employee Payroll Input to Payroll Processing at Provider outbound process agent 504. The process agent 504 invokes a Request GB_Employee Payroll Input Replication operation 506 to request replication of the GB_Employee Payroll Input business object 502, for example, to the Payroll Processing at Provider process component 114. The operation 506 is included in a GB_Employee Payroll Input Replication Out interface 508. The Payroll Processing process component 108 sends information to the Payroll Processing at Provider process component 114 using a Processing at Tenant Out Web Services Reliable Messaging (WSRM) communication channel template 510. The GE_Employee Payroll Input Replication Out interface 508 sends information to the Payroll Processing at Provider 114 using the Processing At Tenant Out Web Services Reliable Messaging (WSRM) communication channel template 510. The communication channel template 510 can define protocols and parameters used for communication with an external party.

The Request GB_Employee Payroll Input Replication operation 506 generates an GB_Employee Payroll Input Replication Request message 512. For example, the message 512 can be sent to the Payroll Processing at Provider process component 114.

The Payroll Processing at Provider process component 114 can send an Employee Payroll Input Replication Confirmation message 514 to the Payroll Processing process component 108. The message 514 is handled in a Maintain GB_Employee Payroll Input Status operation 516. The operation 516 maintains information on the status of the GB_Employee Payroll Input business object 502. The operation 516 is included in an GB_Employee Payroll Input Replication In interface 518. The GB_Employee Payroll Input Replication In interface 518 receives information from the Payroll Processing at Provider process component 114 using a Processing at Tenant In Web Services Reliable Messaging (WSRM) communication channel template 520.

The Maintain GB_Employee Payroll Input Status operation 516 uses a Maintain GB_Employee Payroll Input Status based on Replication Confirmation inbound process agent 522 to update the GB_Employee Payroll Input business object 502.

The Payroll Processing at Provider process component 114 receives information from the Payroll Processing process component 108 using a Processing At Business Partner In Exchange Infrastructure (XI) communication channel template 528. The communication channel template 528 can define protocols and parameters used for communication with an external party. The Payroll Processing at Provider process component 114 also sends information to the Payroll Processing process component 108 using a Processing At Business Partner Out Exchange Infrastructure (XI) communication channel template 526. The communication channel template 526 can define protocols and parameters used for communication with an external party.

Interactions between Process Components “Payroll Processing” and “Payroll Processing at Provider”

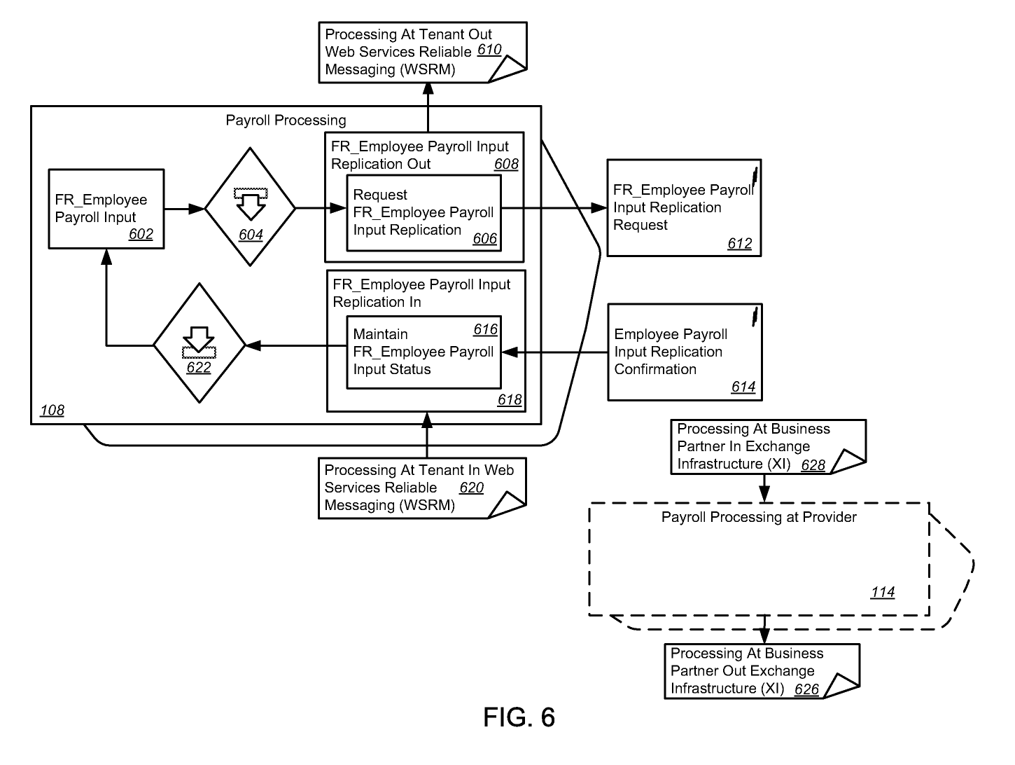

FIG. 6 is a block diagram showing interactions between the Payroll Processing process component 108 and the Payroll Processing at Provider process component 114, related to employee payroll input in France (FR), in the architectural design of FIG. 1. As shown in FIG. 6, the Payroll Processing process component 108 includes a FR_Employee Payroll Input business object 602. The FR_Employee Payroll Input business object 602 represents a summary of all employee-specific input for French payroll for one employee. When a FR_Employee Payroll Input business object 602 has been created, changed, or cancelled, replication can be requested using a Request Replication from FR_Employee Payroll Input to Payroll Processing at Provider outbound process agent 604. The process agent 604 invokes a Request FR_Employee Payroll Input Replication operation 606 to request replication of the FR_Employee Payroll Input business object 602, for example, to the Payroll Processing at Provider process component 114. The operation 606 is included in a FR_Employee Payroll Input Replication Out interface 608. The Payroll Processing process component 108 sends information to the Payroll Processing at Provider process component 114 using a Processing at Tenant Out Web Services Reliable Messaging (WSRM) communication channel template 610. The FR_Employee Payroll Input Replication Out interface 608 sends information to the Payroll Processing at Provider processing component 114 using the Processing At Tenant Out Web Services Reliable Messaging (WSRM) communication channel template 610. The communication channel template 610 can define protocols and parameters used for communication with an external party.

The Request FR_Employee Payroll Input Replication operation 606 generates an FR_Employee Payroll Input Replication Request message 612. For example, the message 612 can be sent to the Payroll Processing at Provider process component 114.

The Payroll Processing at Provider process component 114 can send an Employee Payroll Input Replication Confirmation message 614 to the Payroll Processing process component 108. The message 614 is handled in a Maintain FR_Employee Payroll Input Status operation 616. The operation 616 maintains information on the status of the FR_Employee Payroll Input business object 602. The operation 616 is included in an FR_Employee Payroll Input Replication In interface 618. The FR_Employee Payroll Input Replication In interface 618 receives information from the Payroll Processing at Provider process component 114 using a Processing at Tenant In Web Services Reliable Messaging (WSRM) communication channel template 620.

The Maintain FR_Employee Payroll Input Status operation 616 uses a Maintain FR_Employee Payroll Input Status based on Replication Confirmation inbound process agent 622 to update the FR_Employee Payroll Input business object 602.

The Payroll Processing at Provider process component 114 receives information from the Payroll Processing process component 108 using a Processing At Business Partner In Exchange Infrastructure (XI) communication channel template 628. The communication channel template 628 can define protocols and parameters used for communication with an external party. The Payroll Processing at Provider process component 114 sends information to the Payroll Processing process component 108 using a Processing At Business Partner Out Exchange Infrastructure (XI) communication channel template 626. The communication channel template 626 can define protocols and parameters used for communication with an external party.

Interactions between Process Components “Payroll Processing” and “Accounting”

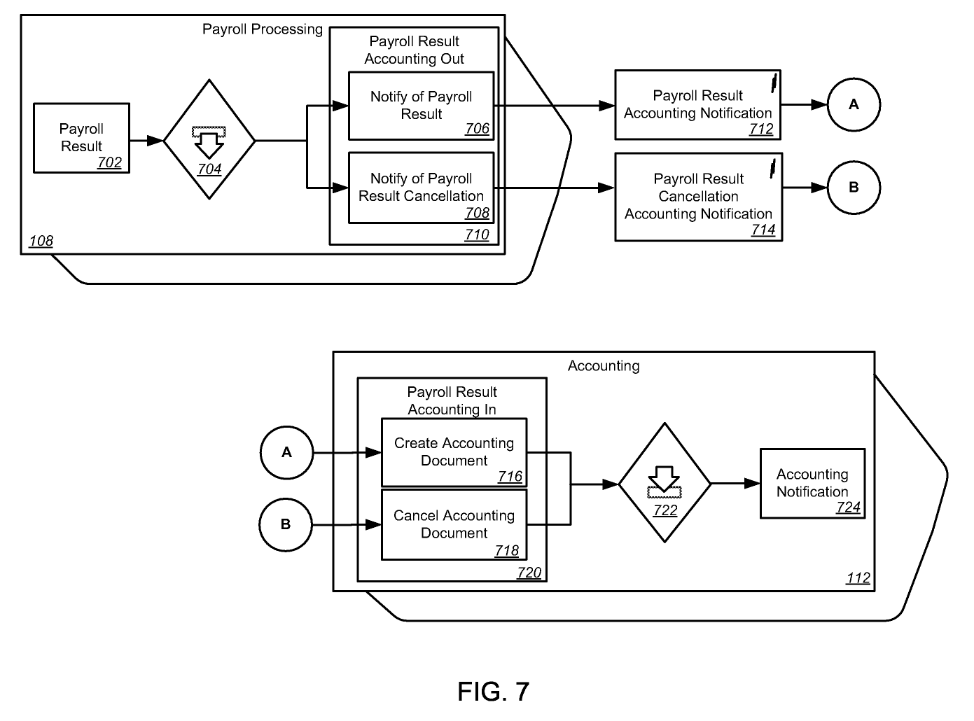

FIG. 7 is a block diagram showing interactions between the Payroll Processing process component 108 and the Accounting process component 112 in the architectural design of FIG. 1. The interaction starts when payroll result information is updated. The Payroll Processing process component 108 requests the creation or cancellation of accounting documents from the Accounting process component 112.

As shown in FIG. 7, the Payroll Processing process component 108 includes a Payroll Result business object 702. The Payroll Result business object 702 represents the aggregated result of a payroll run for a group of employees and the addition of information that is required for a correct transfer to financial accounting.

The Payroll Result business object 702 uses a Notify of Payroll Result to Accounting outbound process agent 704 to invoke a Notify of Payroll Result operation 706 or a Notify of Payroll Result Cancellation operation 708. The Notify of Payroll Result operation 706 and the Notify of Payroll Result Cancellation operation 708 are included in a Payroll Result Accounting Out interface 710.

The Notify of Payroll Result operation 706 forwards accounting-relevant information about payroll processing to the Accounting process component 112 in order to assure posting. The operation 706 generates a Payroll Result Accounting Notification message 712.

The Notify of Payroll Result Cancellation operation 708 cancels accounting-relevant information about payroll processing. The operation 708 generates a Payroll Result Cancellation Accounting Notification message 714.

A Create Accounting Document operation 716 receives the Payroll Result Accounting Notification message 712. The operation 716 receives payroll processing information, for example, from the Payroll Processing process component 108. The Create Accounting Document operation 716 is included in a Payroll Result Accounting In interface 720.

A Cancel Accounting Document operation 718 receives the Payroll Result Cancellation Accounting Notification message 714. The operation 718 receives an invoice accounting cancellation request, for example, from the Payroll Processing process component 108. The Cancel Accounting Document operation 718 is included in the Payroll Result Accounting In interface 720.

The Create Accounting Document operation 716 and the Cancel Accounting Document operation 718 both use a Maintain Accounting Document based on Payroll Result inbound process agent 722 to update the Accounting Notification business object 724. The Accounting Notification business object 724 represents a notification sent to the Accounting process component 112 by an operational component regarding a business transaction. The Accounting Notification business object 724 can represent the operational business transaction in a standardized form for all business transaction documents and can include the data needed to valuate the business transaction.

Interactions between Process Components “Payroll Processing” and “Payroll Processing at Provider”

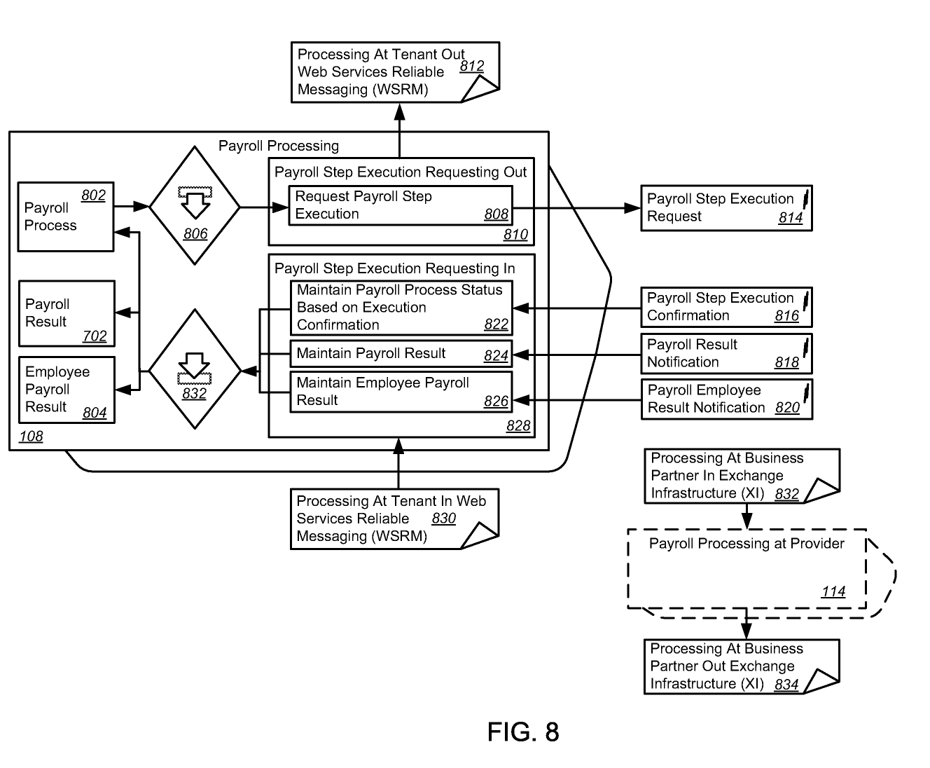

FIG. 8 is a block diagram showing interactions between the Payroll Processing process component 108 and the Payroll Processing at Provider process component 114, related to payroll processing and results, in the architectural design of FIG. 1.

As shown in FIG. 8, the Payroll Processing process component 108 includes three business objects: a Payroll Process business object 802, the Payroll Result business object 702, and an Employee Payroll Result business object 804. The Payroll Process business object 802 represents the process that runs the payroll for a group of employees in a payroll period. The Payroll Result business object 702 represents the aggregated result of a payroll run for a group of employees and the addition of information that is required for a correct transfer to financial accounting. The Employee Payroll Result business object 804 represents the result of a payroll run for an individual employee and the addition of information that is required for a correct transfer to financial accounting.

When the Payroll Process business object 802 has been updated, payroll step execution can be requested using a Request Payroll Step Execution from Payroll Process to Provider outbound process agent 806. The process agent 806 invokes a Request Payroll Step Execution operation 808 to request the execution of a step in the payroll process from the payroll provider. The operation 808 is included in a Payroll Step Execution Requesting Out interface 810. The Payroll Processing process component 108 sends information to the Payroll Processing at Provider process component 114 using a Processing at Tenant Out Web Services Reliable Messaging (WSRM) communication channel template 812. The Payroll Step Execution Requesting Out interface 810 sends information to the Payroll Processing at Provider processing component 114 using the Processing At Tenant Out Web Services Reliable Messaging (WSRM) communication channel template 812. The communication channel template 918 can define protocols and parameters used for communication with an external party.

The Request Payroll Step Execution operation 808 sends a Payroll Step Execution Request message 814. For example, the message 814 can be sent to the Payroll Processing at Provider process component 114.

A Payroll Step Execution Confirmation message 816, a Payroll Result Notification message 818, and an Employee Payroll Result Notification message 820 are generated, for example, by the Payroll Processing at Provider process component 114. The message 816 is handled in a Maintain Payroll Process Status based on Execution Confirmation operation 822. The operation 822 maintains the payroll process status based on the execution confirmation from the payroll provider.

The Payroll Result Notification message 818 is handled in a Maintain Payroll Result operation 824. The operation 824 maintains the payroll result totals for the payroll group included in a payroll process. The Employee Payroll Result Notification message 820 is handled in a Maintain Employee Payroll Result operation 826. The operation 826 maintains the individual payroll result for an employee in a payroll process.

The operations 822, 824, 826 are included in a Payroll Step Execution Requesting In interface 828. The Payroll Step Execution Requesting In interface 828 receives information from the Payroll Processing at Provider process component 114 using a Processing at Tenant In Web Services Reliable Messaging (WSRM) communication channel template 830. The operations 822, 824, 826 use a Maintain Payroll Process Status and Results inbound process agent 832 to update the Payroll Process business object 802, the Payroll Result business object 702, and the Employee Payroll Result business object 804.

The Payroll Processing at Provider process component 114 receives information from the Payroll Processing process component 108 using a Processing At Business Partner Out Exchange Infrastructure (XI) communication channel template 832. The communication channel template 832 can define protocols and parameters used for communication with an external party. The Payroll Processing at Provider process component 114 sends information to the Payroll Processing process component 108 using a Processing At Business Partner In Exchange Infrastructure (XI) communication channel template 834. The communication channel template 834 can define protocols and parameters used for communication with an external party.

Interactions between Process Components “Payroll Processing” and “Payroll Processing at Provider”

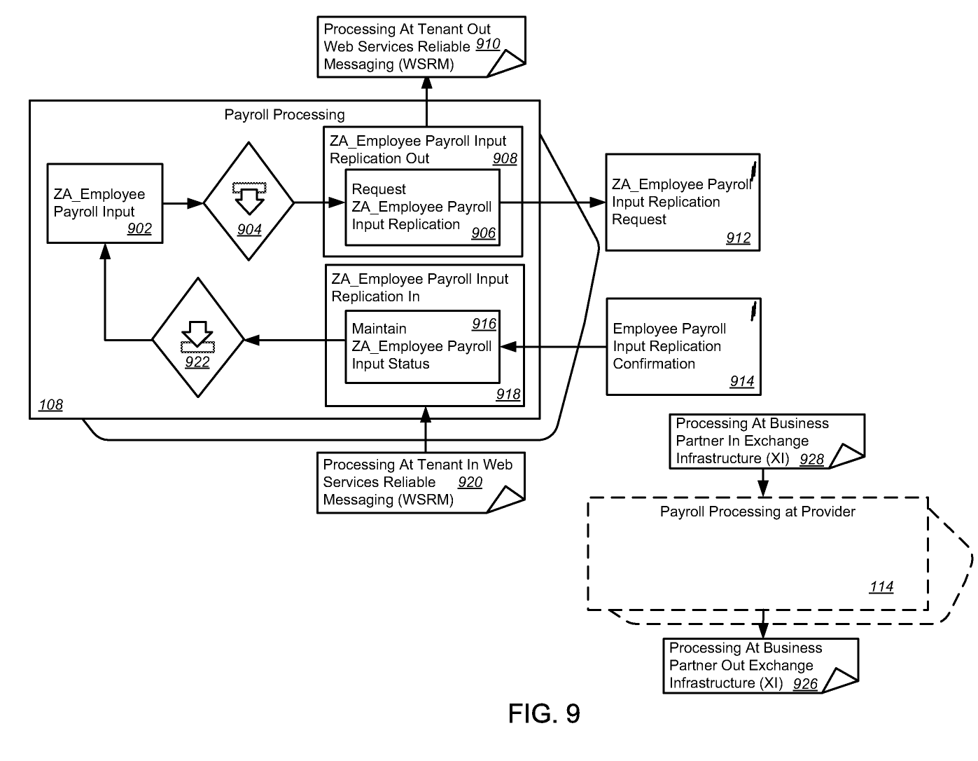

FIG. 9 is a block diagram showing interactions between the Payroll Processing process component 108 and the Payroll Processing at Provider process component 114, related to employee payroll input in South Africa (ZA), in the architectural design of FIG. 1.

As shown in FIG. 9, the Payroll Processing process component 108 includes a ZA_Employee Payroll Input business object 902. The ZA_Employee Payroll Input business object 902 represents a summary of all employee-specific input for South African payroll for one employee. When a ZA_Employee Payroll Input business object 902 has been created, changed, or cancelled, replication can be requested using a Request Replication from ZA_Employee Payroll Input to Payroll Processing at Provider outbound process agent 904. The process agent 904 invokes a Request ZA_Employee Payroll Input Replication operation 906 to request replication of the ZA_Employee Payroll Input business object 902, for example, to the Payroll Processing at Provider process component 114. The operation 906 is included in a ZA_Employee Payroll Input Replication Out interface 908. The Payroll Processing process component 108 sends information to the Payroll Processing at Provider process component 114 using a Processing at Tenant Out Web Services Reliable Messaging (WSRM) communication channel template 910. The ZA_Employee Payroll Input Replication Out interface 908 sends information to the Payroll Processing at Provider processing component 114 using the Processing At Tenant Out Web Services Reliable Messaging (WSRM) communication channel template 910. The communication channel template 910 can define protocols and parameters used for communication with an external party.

The Request ZA_Employee Payroll Input Replication operation 906 generates an ZA_Employee Payroll Input Replication Request message 912. For example, the message 912 can be sent to the Payroll Processing at Provider process component 114.

The Payroll Processing at Provider process component 114 can send an Employee Payroll Input Replication Confirmation message 914 to the Payroll Processing process component 108. The message 914 is handled in a Maintain ZA_Employee Payroll Input Status operation 916. The operation 916 maintains information on the status of the ZA_Employee Payroll Input business object 902. The operation 916 is included in an ZA_Employee Payroll Input Replication In interface 918. The ZA_Employee Payroll Input Replication In interface 918 receives information from the Payroll Processing at Provider process component 114 using a Processing at Tenant In Web Services Reliable Messaging (WSRM) communication channel template 920.

The Maintain ZA_Employee Payroll Input Status operation 916 uses a Maintain ZA_Employee Payroll Input Status based on Replication Confirmation inbound process agent 922 to update the ZA_Employee Payroll Input business object 902.

The Payroll Processing at Provider process component 114 receives information from the Payroll Processing process component 108 using a Processing At Business Partner In Exchange Infrastructure (XI) communication channel template 928. The communication channel template 928 can define protocols and parameters used for communication with an external party. The Payroll Processing at Provider process component 114 sends information to the Payroll Processing process component 108 using a Processing At Business Partner Out Exchange Infrastructure (XI) communication channel template 926. The communication channel template 926 can define protocols and parameters used for communication with an external party.

Interactions between Process Components “Payroll Processing” and “Payroll Processing at Provider”

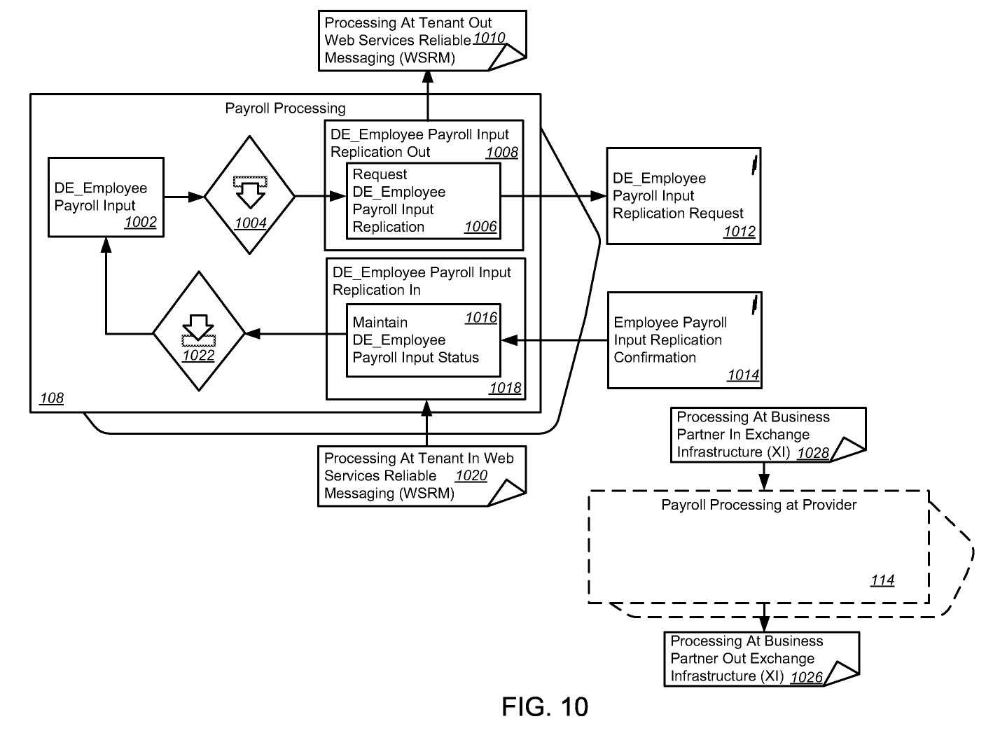

FIG. 10 is a block diagram showing interactions between the Payroll Processing process component 108 and the Payroll Processing at Provider process component 114, related to employee payroll input in Germany (DE), in the architectural design of FIG. 1.

As shown in FIG. 10, the Payroll Processing process component 108 includes a DE_Employee Payroll Input business object 1002. The DE_Employee Payroll Input business object 1002 represents a summary of all employee-specific input for German payroll for one employee. When a DE_Employee Payroll Input business object 1002 has been created, changed, or cancelled, replication can be requested using a Request Replication from DE_Employee Payroll Input to Payroll Processing at Provider outbound process agent 1004. The process agent 1004 invokes a Request DE_Employee Payroll Input Replication operation 1006 to request replication of the DE_Employee Payroll Input business object 1002, for example, to the Payroll Processing at Provider process component 114. The operation 1006 is included in a DE_Employee Payroll Input Replication Out interface 1008. The Payroll Processing process component 108 sends information to the Payroll Processing at Provider process component 114 using a Processing at Tenant Out Web Services Reliable Messaging (WSRM) communication channel template 1010. The DE_Employee Payroll Input Replication Out interface 1008 sends information to the Payroll Processing at Provider processing component 114 using the Processing At Tenant Out Web Services Reliable Messaging (WSRM) communication channel template 1010. The communication channel template 1010 can define protocols and parameters used for communication with an external party.

The Request DE_Employee Payroll Input Replication operation 1006 generates an DE_Employee Payroll Input Replication Request message 1012. For example, the message 1012 can be sent to the Payroll Processing at Provider process component 114.

The Payroll Processing at Provider process component 114 can send an Employee Payroll Input Replication Confirmation message 1014 to the Payroll Processing process component 108. The message 1014 is handled in a Maintain DE_Employee Payroll Input Status operation 1016. The operation 1016 maintains information on the status of the DE_Employee Payroll Input business object 1002. The operation 1016 is included in an DE_Employee Payroll Input Replication In interface 1018. The DE_Employee Payroll Input Replication In interface 1018 receives information from the Payroll Processing at Provider process component 114 using a Processing at Tenant In Web Services Reliable Messaging (WSRM) communication channel template 1020.

The Maintain DE_Employee Payroll Input Status operation 1016 uses a Maintain DE_Employee Payroll Input Status based on Replication Confirmation inbound process agent 1022 to update the DE_Employee Payroll Input business object 1002.

The Payroll Processing at Provider process component 114 receives information from the Payroll Processing process component 108 using a Processing At Business Partner In Exchange Infrastructure (XI) communication channel template 1028. The communication channel template 1028 can define protocols and parameters used for communication with an external party. The Payroll Processing at Provider process component 114 sends information to the Payroll Processing process component 108 using a Processing At Business Partner Out Exchange Infrastructure (XI) communication channel template 1026. The communication channel template 1026 can define protocols and parameters used for communication with an external party.

Interactions between Process Components “Payroll Processing” and “Payroll Processing at Provider”

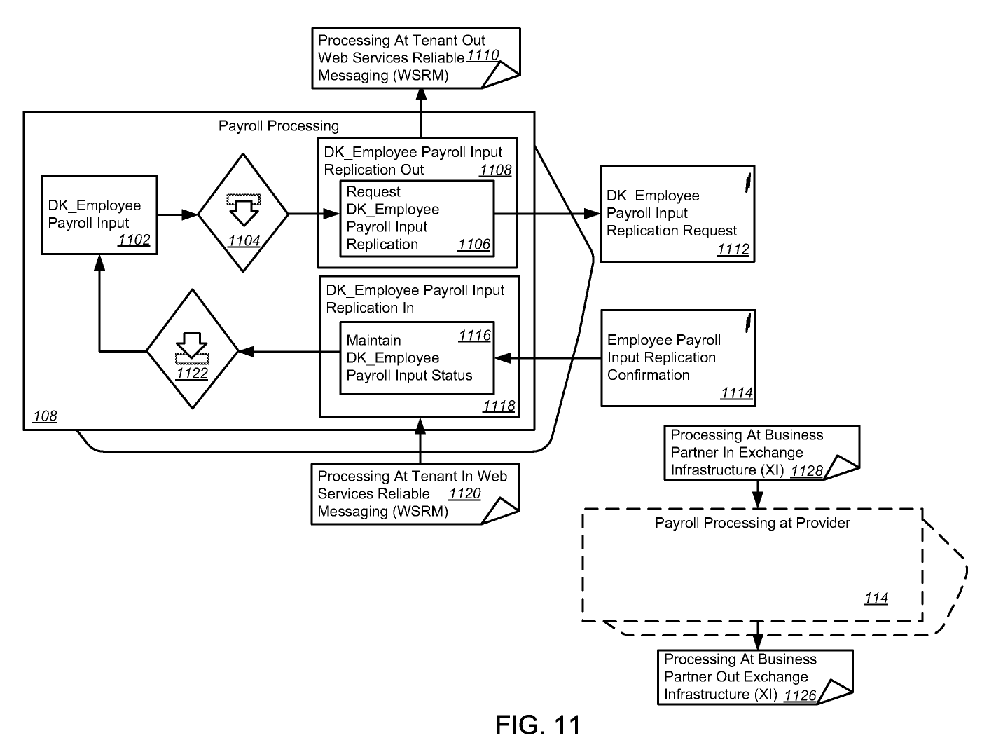

FIG. 11 is a block diagram showing interactions between the Payroll Processing process component 108 and the Payroll Processing at Provider process component 114, related to Denmark (DK) employee payroll input in Denmark (DK), in the architectural design of FIG. 1. As shown in FIG. 11, the Payroll Processing process component 108 includes a DK_Employee Payroll Input business object 1102. The DK_Employee Payroll Input business object 1102 represents a summary of all employee-specific input for Danish payroll for one employee. When a DK_Employee Payroll Input business object 1102 has been created, changed or cancelled, replication can be requested using a Request Replication from DK_Employee Payroll Input to Payroll Processing at Provider outbound process agent 1104. The process agent 1104 invokes a Request DK_Employee Payroll Input Replication operation 1106 to request replication of the DK_Employee Payroll Input business object 1102, for example, to the Payroll Processing at Provider process component 114. The operation 1106 is included in a DK_Employee Payroll Input Replication Out interface 1108. The Payroll Processing process component 108 sends information to the Payroll Processing at Provider process component 114 using a Processing at Tenant Out Web Services Reliable Messaging (WSRM) communication channel template 1110. The DK_Employee Payroll Input Replication Out interface 1108 sends information to the Payroll Processing at Provider processing component 114 using the Processing At Tenant Out Web Services Reliable Messaging (WSRM) communication channel template 1110. The communication channel template 1110 can define protocols and parameters used for communication with an external party.

The Request DK_Employee Payroll Input Replication operation 1106 generates an DK_Employee Payroll Input Replication Request message 1112. For example, the message 1112 can be sent to the Payroll Processing at Provider process component 114.

The Payroll Processing at Provider process component 114 can send an Employee Payroll Input Replication Confirmation message 1114 to the Payroll Processing process component 108. The message 1114 is handled in a Maintain DK_Employee Payroll Input Status operation 1116. The operation 1116 maintains information on the status of the DK_Employee Payroll Input business object 1102. The operation 1116 is included in an DK_Employee Payroll Input Replication In interface 1118. The DK_Employee Payroll Input Replication In interface 1118 receives information from the Payroll Processing at Provider process component 114 using a Processing at Tenant In Web Services Reliable Messaging (WSRM) communication channel template 1120.

The Maintain DK_Employee Payroll Input Status operation 1116 uses a Maintain DK_Employee Payroll Input Status based on Replication Confirmation inbound process agent 1122 to update the DK_Employee Payroll Input business object 1102.

The Payroll Processing at Provider process component 114 receives information from the Payroll Processing process component 108 using a Processing At Business Partner In Exchange Infrastructure (XI) communication channel template 1128. The communication channel template 1128 can define protocols and parameters used for communication with an external party. The Payroll Processing at Provider process component 114 sends information to the Payroll Processing process component 108 using a Processing At Business Partner Out Exchange Infrastructure (XI) communication channel template 1126. The communication channel template 1126 can define protocols and parameters used for communication with an external party.

Interactions between Process Components “Payroll Processing” and “Payroll Processing at Provider”

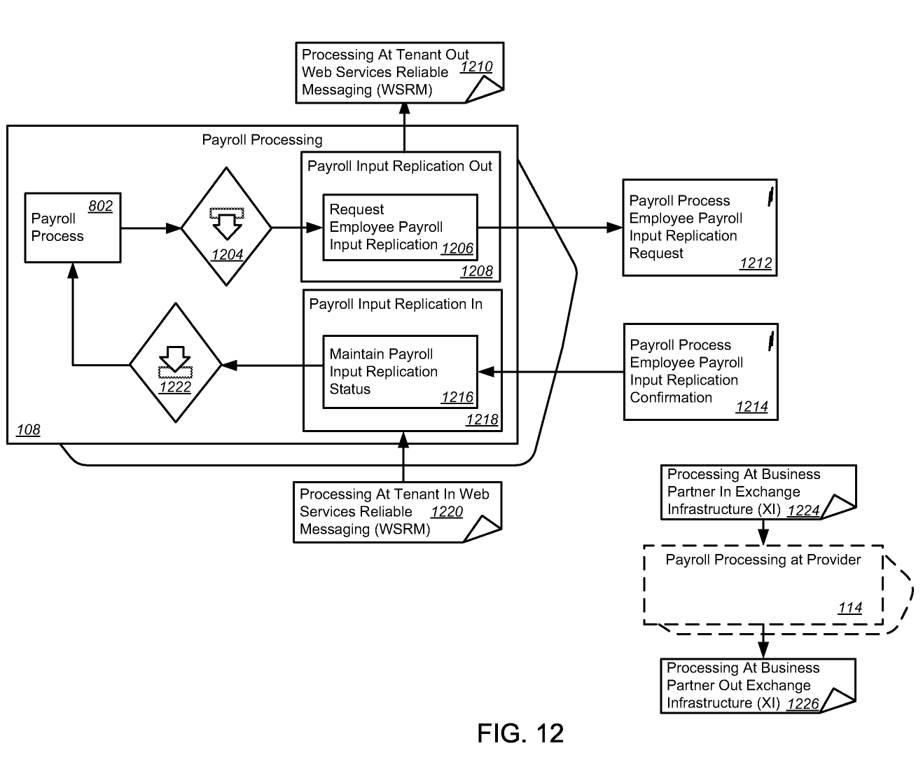

FIG. 12 is a block diagram showing interactions between the Payroll Processing process component 108 and the Payroll Processing at Provider process component 114, related to a payroll process, in the architectural design of FIG. 1.

As shown in FIG. 12, the Payroll Processing process component 108 includes the Payroll Process business object 802. The Payroll Process business object 802 represents a process that runs the payroll for a group of employees in a payroll period. When a Payroll Process business object 802 has been created, changed or cancelled, replication can be requested using a Request Payroll Input Replication from Payroll Process to Provider outbound process agent 1204. The process agent 1204 invokes a Request Employee Payroll Input Replication operation 1206 to request the replication of employee payroll input on a payroll group level. The operation 1206 is included in a Payroll Input Replication Out interface 1208. The Payroll Processing process component 108 sends information to the Payroll Processing at Provider process component 114 using a Processing at Tenant Out Web Services Reliable Messaging (WSRM) communication channel template 1210. The Payroll Input Replication Out interface 1208 sends information to the Payroll Processing at Provider processing component 114 using the Processing At Tenant Out Web Services Reliable Messaging (WSRM) communication channel template 1210. The communication channel template 1210 can define protocols and parameters used for communication with an external party.

The Request Employee Payroll Input Replication operation 1206 sends a Payroll Process Employee Payroll Input Replication Request message 1212. For example, the message 1212 can be sent to the Payroll Processing at Provider process component 114.

A Payroll Process Employee Payroll Input Replication Confirmation message 1214 is generated by the Payroll Processing at Provider process component 114. The message 1214 is handled in a Maintain Payroll Input Replication Status operation 1216. The operation 1216 maintains the payroll input replication status based on the payroll provider confirmation. The Maintain Payroll Input Replication Status operation 1216 is included in a Payroll Input Replication In interface 1218. The Payroll Input Replication In interface 1218 receives information from the Payroll Processing at Provider process component 114 using a Processing at Tenant In Web Services Reliable Messaging (WSRM) communication channel template 1220. The communication channel template 1220 can define protocols and parameters used for communication with an external party. The Maintain Payroll Input Replication Status operation 1216 uses a Maintain Payroll Input Replication Status inbound process agent 1222 to update the Payroll Process business object 802.

The Payroll Processing at Provider process component 114 receives information from the Payroll Processing process component 108 using a Processing At Business Partner In Exchange Infrastructure (XI) communication channel template 1224. The communication channel template 1224 can define protocols and parameters used for communication with an external party. The Payroll Processing at Provider process component 114 sends information to the Payroll Processing process component 108 using a Processing At Business Partner Out Exchange Infrastructure (XI) communication channel template 1226. The communication channel template 1226 can define protocols and parameters used for communication with an external party.

Interactions between Process Components “Payroll Processing” and “Payroll Processing at Provider”

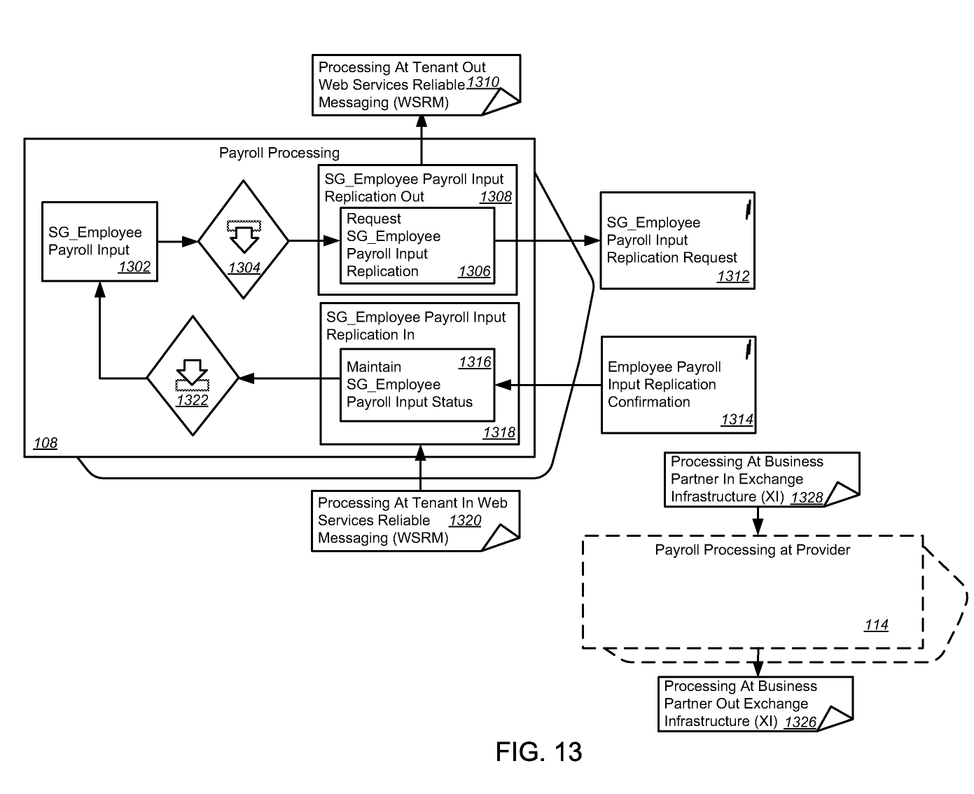

FIG. 13 is a block diagram showing interactions between the Payroll Processing process component 108 and the Payroll Processing at Provider process component 114, related to employee payroll input in Singapore (SG), in the architectural design of FIG. 1. As shown in FIG. 13, the Payroll Processing process component 108 includes a SG_Employee Payroll Input business object 1302. The SG_Employee Payroll Input business object 1302 represents a summary of all employee-specific input for Singaporean payroll for one employee. When a SG_Employee Payroll Input business object 1302 has been created, changed or cancelled, replication can be requested using a Request Replication from SG_Employee Payroll Input to Payroll Processing at Provider outbound process agent 1304. The process agent 1304 invokes a Request SG_Employee Payroll Input Replication operation 1306 to request replication of the SG_Employee Payroll Input business object 1302, for example, to the Payroll Processing at Provider process component 114. The operation 1306 is included in a SG_Employee Payroll Input Replication Out interface 1308. The Payroll Processing process component 108 sends information to the Payroll Processing at Provider process component 114 using a Processing at Tenant Out Web Services Reliable Messaging (WSRM) communication channel template 1310. The SG_Employee Payroll Input Replication Out interface 1308 sends information to the Payroll Processing at Provider processing component 114 using the Processing At Tenant Out Web Services Reliable Messaging (WSRM) communication channel template 13 10. The communication channel template 1310 can define protocols and parameters used for communication with an external party.

The Request SG_Employee Payroll Input Replication operation 1306 generates a SG_Employee Payroll Input Replication Request message 1312. For example, the message 1312 can be sent to the Payroll Processing at Provider process component 114.

The Payroll Processing at Provider process component 114 can send an Employee Payroll Input Replication Confirmation message 1314 to the Payroll Processing process component 108. The message 1314 is handled in a Maintain SG_Employee Payroll Input Status operation 1316. The operation 1316 maintains information on the status of the SG_Employee Payroll Input business object 1302. The operation 1316 is included in an SG_Employee Payroll Input Replication In interface 1318. The SG_Employee Payroll Input Replication In interface 1318 receives information from the Payroll Processing at Provider process component 114 using a Processing at Tenant In Web Services Reliable Messaging (WSRM) communication channel template 1320.

The Maintain SG_Employee Payroll Input Status operation 1316 uses a Maintain SG_Employee Payroll Input Status based on Replication Confirmation inbound process agent 1322 to update the SG_Employee Payroll Input business object 1302.

The Payroll Processing at Provider process component 114 receives information from the Payroll Processing process component 108 using a Processing At Business Partner In Exchange Infrastructure (XI) communication channel template 1328. The communication channel template 1328 can define protocols and parameters used for communication with an external party. The Payroll Processing at Provider process component 114 sends information to the Payroll Processing process component 108 using a Processing At Business Partner Out Exchange Infrastructure (XI) communication channel template 1326. The communication channel template 1326 can define protocols and parameters used for communication with an external party.

Interactions between Process Components “Payroll Processing” and “Payroll Processing at Provider”

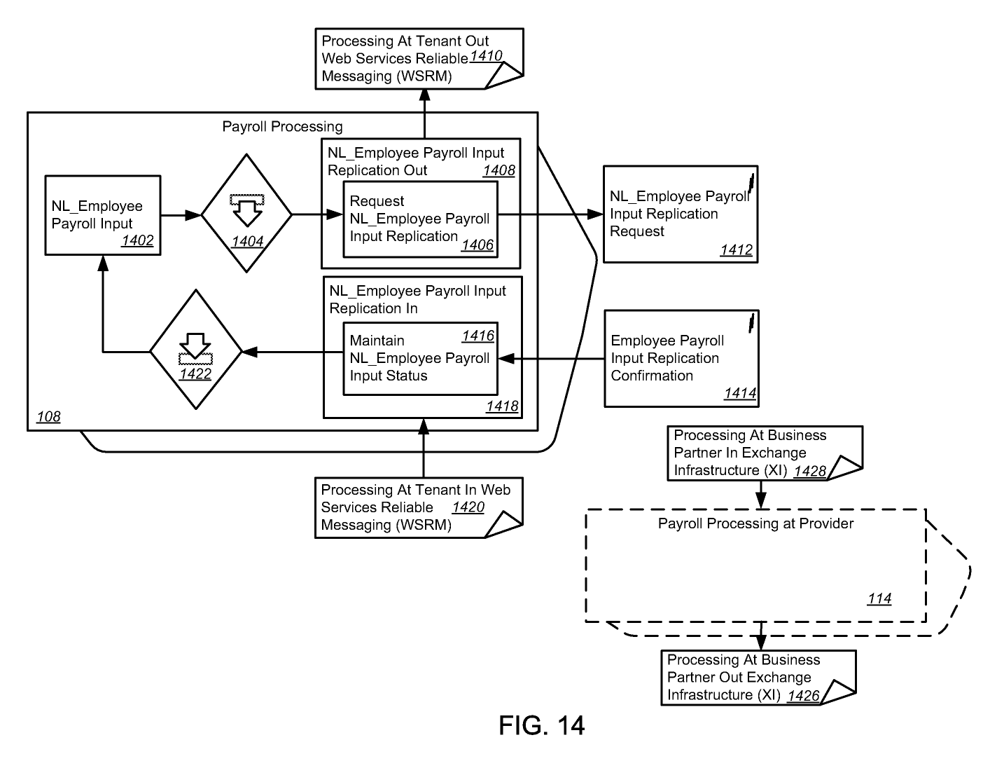

FIG. 14 is a block diagram showing interactions between the Payroll Processing process component 108 and the Payroll Processing at Provider process component 114, related to employee payroll input in the Netherlands (NL), in the architectural design of FIG. 1.

As shown in FIG. 14, the Payroll Processing process component 108 includes a NL_Employee Payroll Input business object 1402. The NL_Employee Payroll Input business object 1402 represents a summary of all employee-specific input for Dutch payroll for one employee. When a NL_Employee Payroll Input business object 1402 has been created, changed or cancelled, replication can be requested using a Request Replication from NL_Employee Payroll Input to Payroll Processing at Provider outbound process agent 1404. The process agent 1404 invokes a Request NL_Employee Payroll Input Replication operation 1406 to request replication of the NL_Employee Payroll Input business object 1402, for example, to the Payroll Processing at Provider process component 114. The operation 1406 is included in a NL_Employee Payroll Input Replication Out interface 1408. The Payroll Processing process component 108 sends information to the Payroll Processing at Provider process component 114 using a Processing at Tenant Out Web Services Reliable Messaging (WSRM) communication channel template 1410. The NL_Employee Payroll Input Replication Out interface 1408 sends information to the Payroll Processing at Provider processing component 114 using the Processing At Tenant Out Web Services Reliable Messaging (WSRM) communication channel template 1410. The communication channel template 1410 can define protocols and parameters used for communication with an external party.

The Request NL_Employee Payroll Input Replication operation 1406 generates a NL_Employee Payroll Input Replication Request message 1412. For example, the message 1412 can be sent to the Payroll Processing at Provider process component 114.

The Payroll Processing at Provider process component 114 can send an Employee Payroll Input Replication Confirmation message 1414 to the Payroll Processing process component 108. The message 1414 is handled in a Maintain NL_Employee Payroll Input Status operation 1416. The operation 1416 maintains information on the status of the NL_Employee Payroll Input business object 1402. The operation 1416 is included in an NL_Employee Payroll Input Replication In interface 1418. The NL_Employee Payroll Input Replication In interface 1418 receives information from the Payroll Processing at Provider process component 114 using a Processing at Tenant In Web Services Reliable Messaging (WSRM) communication channel template 1420.

The Maintain NL_Employee Payroll Input Status operation 1416 uses a Maintain NL_Employee Payroll Input Status based on Replication Confirmation inbound process agent 1422 to update the NL_Employee Payroll Input business object 1402.

The Payroll Processing at Provider process component 114 receives information from the Payroll Processing process component 108 using a Processing At Business Partner In Exchange Infrastructure (XI) communication channel template 1428. The communication channel template 1428 can define protocols and parameters used for communication with an external party. The Payroll Processing at Provider process component 114 sends information to the Payroll Processing process component 108 using a Processing At Business Partner Out Exchange Infrastructure (XI) communication channel template 1426. The communication channel template 1426 can define protocols and parameters used for communication with an external party.

Interactions between Process Components “Payroll Processing” and “Payroll Processing at Provider”

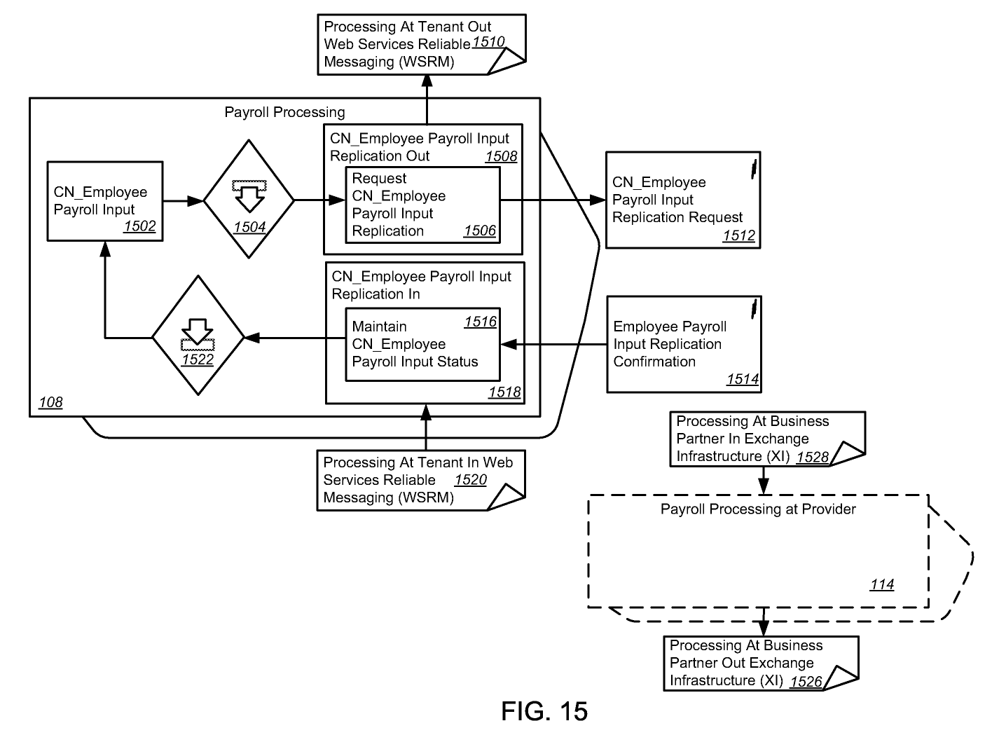

FIG. 15 is a block diagram showing interactions between the Payroll Processing process component 108 and the Payroll Processing at Provider process component 114, related to employee payroll input in China (CN), in the architectural design of FIG. 1. As shown in FIG. 15, the Payroll Processing process component 108 includes a CN_Employee Payroll Input business object 1502. The CN_Employee Payroll Input business object 1502 represents a summary of all employee-specific input for Chinese payroll for one employee. When a CN_Employee Payroll Input business object 1502 has been created, changed or cancelled, replication can be requested using a Request Replication from CN_Employee Payroll Input to Payroll Processing at Provider outbound process agent 1504. The process agent 1504 invokes a Request CN_Employee Payroll Input Replication operation 1506 to request replication of the CN_Employee Payroll Input business object 1502, for example, to the Payroll Processing at Provider process component 114. The operation 1506 is included in a CN_Employee Payroll Input Replication Out interface 1508. The Payroll Processing process component 108 sends information to the Payroll Processing at Provider process component 114 using a Processing at Tenant Out Web Services Reliable Messaging (WSRM) communication channel template 1510. The CN_Employee Payroll Input Replication Out interface 1508 sends information to the Payroll Processing at Provider processing component 114 using the Processing At Tenant Out Web Services Reliable Messaging (WSRM) communication channel template 1510. The communication channel template 1510 can define protocols and parameters used for communication with an external party.

The Request CN_Employee Payroll Input Replication operation 1506 generates a CN_Employee Payroll Input Replication Request message 1512. For example, the message 1512 can be sent to the Payroll Processing at Provider process component 114.

The Payroll Processing at Provider process component 114 can send an Employee Payroll Input Replication Confirmation message 1514 to the Payroll Processing process component 108. The message 1514 is handled in a Maintain CN_Employee Payroll Input Status operation 1516. The operation 1516 maintains information on the status of the CN_Employee Payroll Input business object 1502. The operation 1516 is included in an CN_Employee Payroll Input Replication In interface 1518. The CN_Employee Payroll Input Replication In interface 1518 receives information from the Payroll Processing at Provider process component 114 using a Processing at Tenant In Web Services Reliable Messaging (WSRM) communication channel template 1520.

The Maintain CN_Employee Payroll Input Status operation 1516 uses a Maintain CN_Employee Payroll Input Status based on Replication Confirmation inbound process agent 1522 to update the CN_Employee Payroll Input business object 1502.

The Payroll Processing at Provider process component 114 receives information from the Payroll Processing process component 108 using a Processing At Business Partner In Exchange Infrastructure (XI) communication channel template 1528. The communication channel template 1528 can define protocols and parameters used for communication with an external party. The Payroll Processing at Provider process component 114 sends information to the Payroll Processing process component 108 using a Processing At Business Partner Out Exchange Infrastructure (XI) communication channel template 1526. The communication channel template 1526 can define protocols and parameters used for communication with an external party.

Interactions between Process Components “Payroll Processing” and “Payroll Processing at Provider”

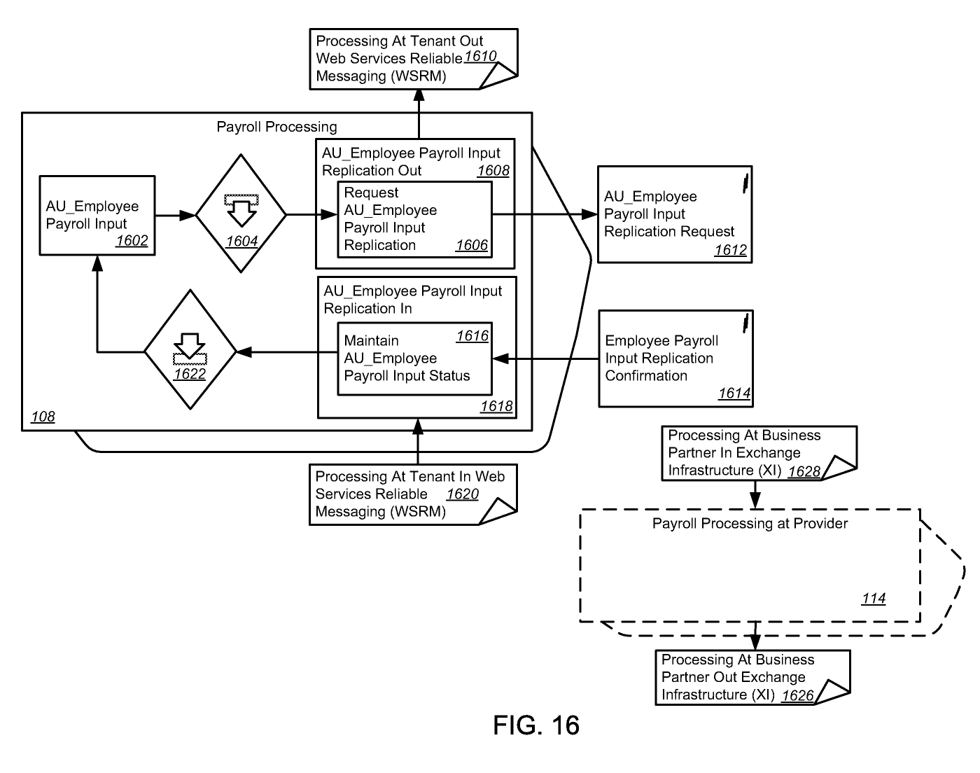

FIG. 16 is a block diagram showing interactions between the Payroll Processing process component 108 and the Payroll Processing at Provider process component 114, related to employee payroll input in Australia (AU), in the architectural design of FIG. 1.

As shown in FIG. 16, the Payroll Processing process component 108 includes a AU_Employee Payroll Input business object 1602. The AU_Employee Payroll Input business object 1602 represents a summary of all employee-specific input for Australian payroll for one employee. When a AU_Employee Payroll Input business object 1602 has been created, changed or cancelled, replication can be requested using a Request Replication from AU_Employee Payroll Input to Payroll Processing at Provider outbound process agent 1604. The process agent 1604 invokes a Request AU_Employee Payroll Input Replication operation 1606 to request replication of the AU_Employee Payroll Input business object 1602, for example, to the Payroll Processing at Provider process component 114. The operation 1606 is included in a AU_Employee Payroll Input Replication Out interface 1608. The Payroll Processing process component 108 sends information to the Payroll Processing at Provider process component 114 using a Processing at Tenant Out Web Services Reliable Messaging (WSRM) communication channel template 1610. The AU_Employee Payroll Input Replication Out interface 1608 sends information to the Payroll Processing at Provider processing component 114 using the Processing At Tenant Out Web Services Reliable Messaging (WSRM) communication channel template 1610. The communication channel template 1610 can define protocols and parameters used for communication with an external party.

The Request AU_Employee Payroll Input Replication operation 1606 generates a AU_Employee Payroll Input Replication Request message 1612. For example, the message 1612 can be sent to the Payroll Processing at Provider process component 114.

The Payroll Processing at Provider process component 114 can send an Employee Payroll Input Replication Confirmation message 1614 to the Payroll Processing process component 108. The message 1614 is handled in a Maintain AU_Employee Payroll Input Status operation 1616. The operation 1616 maintains information on the status of the AU_Employee Payroll Input business object 1602. The operation 1616 is included in an AU_Employee Payroll Input Replication In interface 1618. The AU_Employee Payroll Input Replication In interface 1618 receives information from the Payroll Processing at Provider process component 114 using a Processing at Tenant In Web Services Reliable Messaging (WSRM) communication channel template 1620.

The Maintain AU_Employee Payroll Input Status operation 1616 uses a Maintain AU_Employee Payroll Input Status based on Replication Confirmation inbound process agent 1622 to update the AU_Employee Payroll Input business object 1602.

The Payroll Processing at Provider process component 114 receives information from the Payroll Processing process component 108 using a Processing At Business Partner In Exchange Infrastructure (XI) communication channel template 1628. The communication channel template 1628 can define protocols and parameters used for communication with an external party. The Payroll Processing at Provider process component 114 sends information to the Payroll Processing process component 108 using a Processing At Business Partner Out Exchange Infrastructure (XI) communication channel template 1626. The communication channel template 1626 can define protocols and parameters used for communication with an external party.

Interactions between Process Components “Payroll Processing at Provider” and “Payroll Processing”

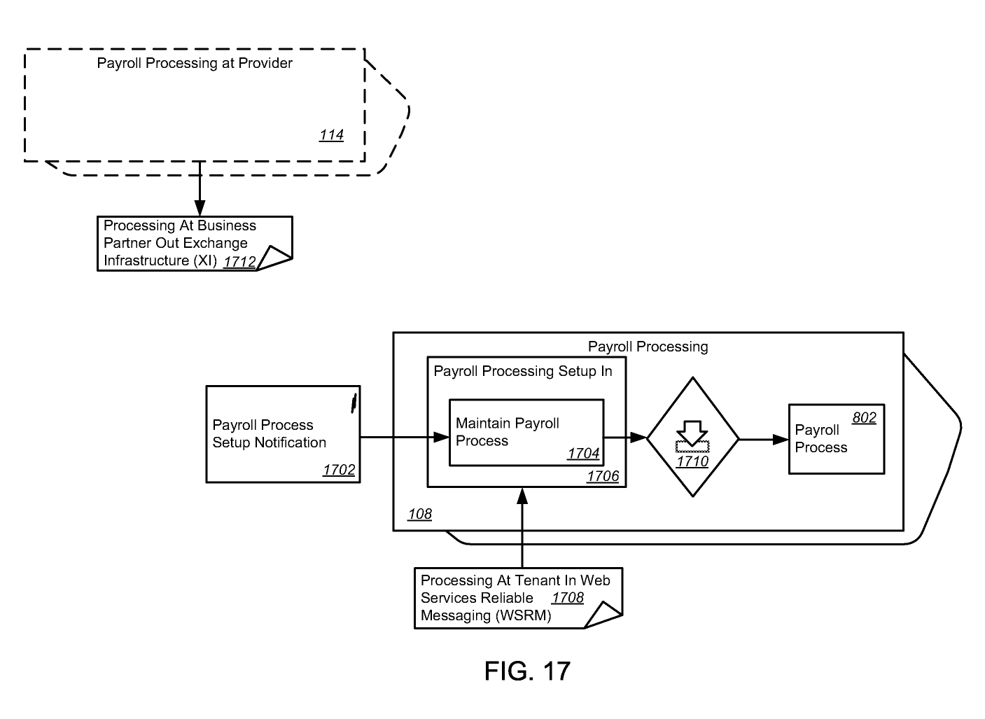

FIG. 17 is a block diagram showing interactions between the Payroll Processing at Provider process component 114 and the Payroll Processing process component 108 in the architectural design of FIG. 1. As shown in FIG. 17, a Payroll Process Setup Notification message 1702 is generated by the Payroll Processing at Provider process component 114. The message 1702 is handled in a Maintain Payroll Process operation 1704. The operation 1704 notifies the payroll process that the payroll provider is ready with the setups required for the country-specific payroll run. For example, the payroll run can be for a payroll group over a specified payroll period. The Maintain Payroll Process operation 1704 is included in a Payroll Processing Setup In interface 1706. The Payroll Processing Setup In interface 1706 receives information from the Payroll Processing at Provider process component 114 using a Processing at Tenant In Web Services Reliable Messaging (WSRM) communication channel template 1708. The communication channel template 1708 can define protocols and parameters used for communication with an external party.

The Maintain Payroll Process operation 1704 uses a Maintain Payroll Process based on Provider Setup inbound process agent 1710 to update the Payroll Process business object 802. The Payroll Process business object 802 represents a process that runs the payroll for a group of employees in a payroll period.

The Payroll Processing at Provider process component 114 sends information from the Payroll Processing process component 108 using a Processing At Business Partner Out Exchange Infrastructure (XI) communication channel template 1712. The communication channel template 1712 can define protocols and parameters used for communication with an external party.

Interactions between Process Components “Payroll Processing” and “Payroll Processing at Provider”

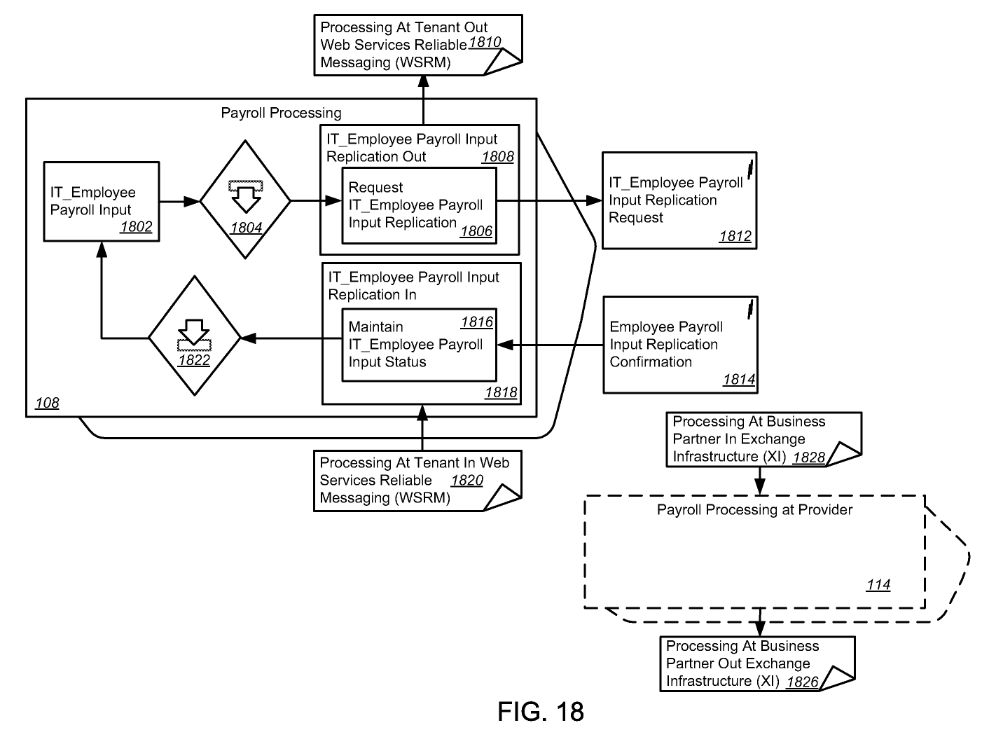

FIG. 18 is a block diagram showing interactions between the Payroll Processing process component 108 and the Payroll Processing at Provider process component 114, related to employee payroll input in Italy (IT), in the architectural design of FIG. 1.

As shown in FIG. 18, the Payroll Processing process component 108 includes a IT_Employee Payroll Input business object 1802. The IT_Employee Payroll Input business object 1802 represents a summary of all employee-specific input for Italian payroll for one employee. When a IT_Employee Payroll Input business object 1802 has been created, changed or cancelled, replication can be requested using a Request Replication from IT_Employee Payroll Input to Payroll Processing at Provider outbound process agent 1804. The process agent 1804 invokes a Request IT_Employee Payroll Input Replication operation 1806 to request replication of the IT_Employee Payroll Input business object 1802, for example, to the Payroll Processing at Provider process component 114. The operation 1806 is included in a IT_Employee Payroll Input Replication Out interface 1808. The Payroll Processing process component 108 sends information to the Payroll Processing at Provider process component 114 using a Processing at Tenant Out Web Services Reliable Messaging (WSRM) communication channel template 1810. The IT_Employee Payroll Input Replication Out interface 1808 sends information to the Payroll Processing at Provider processing component 114 using the Processing At Tenant Out Web Services Reliable Messaging (WSRM) communication channel template 1810. The communication channel template 1810 can define protocols and parameters used for communication with an external party.

The Request IT_Employee Payroll Input Replication operation 1806 generates a IT_Employee Payroll Input Replication Request message 1812. For example, the message 1812 can be sent to the Payroll Processing at Provider process component 114.

The Payroll Processing at Provider process component 114 can send an Employee Payroll Input Replication Confirmation message 1814 to the Payroll Processing process component 108. The message 1814 is handled in a Maintain IT_Employee Payroll Input Status operation 1816. The operation 1816 maintains information on the status of the IT_Employee Payroll Input business object 1802. The operation 1816 is included in an IT_Employee Payroll Input Replication In interface 1818. The IT_Employee Payroll Input Replication In interface 1818 receives information from the Payroll Processing at Provider process component 114 using a Processing at Tenant In Web Services Reliable Messaging (WSRM) communication channel template 1820.

The Maintain IT_Employee Payroll Input Status operation 1816 uses a Maintain IT_Employee Payroll Input Status based on Replication Confirmation inbound process agent 1822 to update the IT_Employee Payroll Input business object 1802.

The Payroll Processing at Provider process component 114 receives information from the Payroll Processing process component 108 using a Processing At Business Partner In Exchange Infrastructure (XI) communication channel template 1828. The communication channel template 1828 can define protocols and parameters used for communication with an external party. The Payroll Processing at Provider process component 114 sends information to the Payroll Processing process component 108 using a Processing At Business Partner Out Exchange Infrastructure (XI) communication channel template 1826. The communication channel template 1826 can define protocols and parameters used for communication with an external party.

Interactions between Process Components “Payroll Processing” and “Employee Payroll Administration”

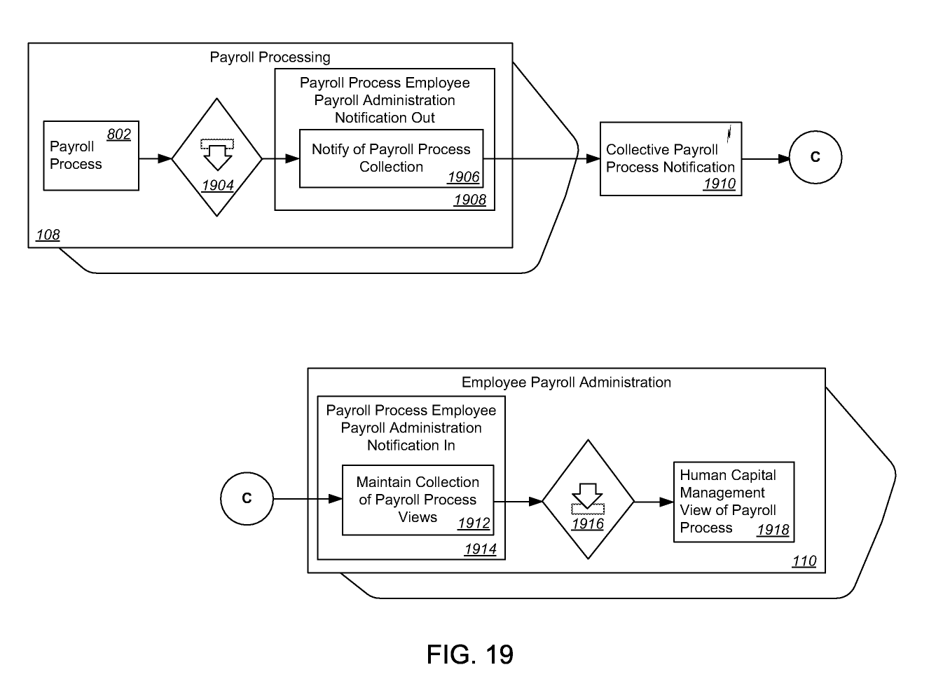

FIG. 19 is a block diagram showing interactions between the Payroll Processing process component 108 and the Employee Payroll Administration process component 110 in the architectural design of FIG. 1.

As shown in FIG. 19, the Payroll Processing process component 108 includes the Payroll Process business object 802. The Payroll Process business object 802 represents a process that runs the payroll for a group of employees in a payroll period. When a Payroll Process business object 802 has been created, changed or cancelled, collective payroll process notification can be requested using a Notify of Payroll Process to Employee Payroll Administration outbound process agent 1904. The process agent 1904 invokes a Notify of Payroll Process Collection operation 1906 to make notification of changes in the payroll process to the view of the payroll process in the Human Capital Management deployment unit 104. The operation 1906 is included in a Payroll Process Employee Payroll Administration Notification Out interface 1908. The operation 1906 sends a Collective Payroll Process Notification message 1910. For example, the message 1910 can be sent to the Employee Payroll Administration process component 110.

The Collective Payroll Process Notification message 1910 is handled in a Maintain Collection of Payroll Process Views operation 1912. The operation 1912 notifies the view of the payroll process in the Human Capital Management deployment unit 104 of changes to the Payroll Process business object 802. The operation 1912 is included in a Payroll Process Employee Payroll Administration Notification In interface 1914. The operation 1912 uses a Maintain View Of Payroll Process based on Payroll Process Notification inbound process agent 1916 to update the Human Capital Management View of Payroll Process business object 1918. The Human Capital Management View of Payroll Process business object 1918 represents a view from the Human Capital Management deployment unit 104 of a payroll process.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the present disclosure or of what may be claimed, but rather as an exemplification of preferred embodiments of the present disclosure. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
a payroll processing process component that handles the execution and monitoring of regular as well as off-cycle payroll processes;
an employee payroll administration process component that handles the administration of the employee specific payroll agreement and the overview of completed and planned payroll processes;
an accounting process component that represents relevant business transactions for valuation and profitability analysis; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the payroll processing process component and the accounting process component; and
the payroll processing process component and the employee payroll administration process component.

2. The product of claim 1, wherein:
the plurality of process components further include a payroll processing at provider process component that handles the execution and monitoring of regular as well as off-cycle payroll processes, including completeness checks of payroll relevant employee data, the payroll run itself, verification of the results, and the transfer to financial accounting; and
the pair-wise interactions between pairs of the process components further include interactions between:
the payroll processing at provider process component and the payroll processing process component; and
the payroll processing process component and the payroll processing at provider process component related to Italy employee payroll input;
the payroll processing process component and the payroll processing at provider process component related to payroll processing and results;
the payroll processing process component and the payroll processing at provider process component related to South Africa employee payroll input;
the payroll processing process component and the payroll processing at provider process component related to Germany employee payroll input;
the payroll processing process component and the payroll processing at provider process component related to Denmark employee payroll input;
the payroll processing process component and the payroll processing at provider process component related to a payroll process;
the payroll processing process component and the payroll processing at provider process component related to Singapore employee payroll input;
the payroll processing process component and the payroll processing at provider process component related to Netherlands employee payroll input;
the payroll processing process component and the payroll processing at provider process component related to China employee payroll input;
the payroll processing process component and the payroll processing at provider process component related to Australia employee payroll input;
the payroll processing process component and the payroll processing at provider process component related to Canada employee payroll input;
the payroll processing process component and the payroll processing at provider process component related to United States employee payroll input;
the payroll processing process component and the payroll processing at provider process component related to Great Britain employee payroll input; and
the payroll processing process component and the payroll processing at provider process component related to France employee payroll input.

3. The product of claim 1, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

4. The product of claim 3, wherein the deployment units comprise:
a payroll deployment unit includes the payroll processing process component;
a human capital management deployment unit includes the employee payroll administration process component; and
a financial accounting deployment unit includes the accounting process component.

5. The product of claim 1, wherein:
each of the process components includes one or more business objects; and
none of the business objects of any one of the process components interacts directly with any of the business objects included in any of the other process components.

6. The product of claim 5, wherein the business objects comprise a business process object.

7. The product of claim 5, wherein none of the business objects included in any one of the process components is included in any of the other process components.

8. The product of claim 1, further comprising:
a plurality of process agents, each process agent being either an inbound process agent or an outbound process agent, an inbound process agent being operable to receive a message from an inbound operation, an outbound process agent being operable to cause an outbound operation to send a message, and each process agent being associated with exactly one process component.

9. The product of claim 8, wherein the inbound process agents comprise a first inbound process agent operable to start the execution of step requested in a first inbound message by creating or updating one or more business object instances.

10. The product of claim 8, wherein the outbound process agents comprise a first asynchronous outbound process agent that is called after a business object that is associated with the first outbound process agent changes.

11. The product of claim 1, wherein the operations comprise synchronous and asynchronous operations.

12. A system, comprising:
a computer system comprising one or more hardware platforms for executing a computer software application;
a plurality of process components, each of the process components being a package of software implementing a respective and distinct business process, the plurality of process components including:
a payroll processing process component that handles the execution and monitoring of regular as well as off-cycle payroll processes;
an employee payroll administration process component that handles the administration of the employee specific payroll agreement and the overview of completed and planned payroll processes; and
an accounting process component that represents relevant business transactions for valuation and profitability analysis; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the payroll processing process component and the accounting process component; and
the payroll processing process component and the employee payroll administration process component.

13. The system of claim 12, wherein:
the plurality of process components further includes a payroll processing at provider process component that handles the execution and monitoring of regular as well as off-cycle payroll processes, including completeness checks of payroll relevant employee data, the payroll run itself, verification of the results, and the transfer to financial accounting; and
the pair-wise interactions between pairs of the process components include interactions between:
the payroll processing at provider process component and the payroll processing process component; and
the payroll processing process component and the payroll processing at provider process component related to Italy employee payroll input;
the payroll processing process component and the payroll processing at provider process component related to payroll processing and results;
the payroll processing process component and the payroll processing at provider process component related to South Africa employee payroll input;
the payroll processing process component and the payroll processing at provider process component related to Germany employee payroll input;
the payroll processing process component and the payroll processing at provider process component related to Denmark employee payroll input;
the payroll processing process component and the payroll processing at provider process component related to a payroll process;
the payroll processing process component and the payroll processing at provider process component related to Singapore employee payroll input;
the payroll processing process component and the payroll processing at provider process component related to Netherlands employee payroll input;
the payroll processing process component and the payroll processing at provider process component related to China employee payroll input;
the payroll processing process component and the payroll processing at provider process component related to Australia employee payroll input;
the payroll processing process component and the payroll processing at provider process component related to Canada employee payroll input;
the payroll processing process component and the payroll processing at provider process component related to United States employee payroll input;
the payroll processing process component and the payroll processing at provider process component related to Great Britain employee payroll input; and
the payroll processing process component and the payroll processing at provider process component related to France employee payroll input.

14. The system of claim 12, wherein:
each of the process components includes one or more business objects; and
none of the business objects of any one of the process components interacts directly with any of the business objects included in any of the other process components.

15. The system of claim 12, wherein none of the business objects included in any one of the process components is included in any of the other process components.

16. The system of claim 12, further comprising a plurality of process agents, each process agent being either an inbound process agent or an outbound process agent, an inbound process agent being operable to receive a message from an inbound operation, an outbound process agent being operable to cause an outbound operation to send a message, and each process agent being associated with exactly one process component.

17. The system of claim 12, the system comprising multiple hardware platforms, wherein:
the payroll processing process component is deployed on a first hardware platform;
the employee payroll administration process component is deployed on a second hardware platform; and
the accounting process component is deployed on a third hardware platform.

18. The system of claim 17, wherein each of the first through the third hardware platforms are distinct and separate from each other.

19. A method for developing a computer software application, comprising:
obtaining in a computer system digital data representing an architectural design for a set of processes implementing an end-to-end application process, the design specifying a process component for each process in the set of processes and the design further specifying a set of process component interactions, wherein:
the specified process components include:
a payroll processing process component that handles the execution and monitoring of regular as well as off-cycle payroll processes;
an employee payroll administration process component that handles the administration of the employee specific payroll agreement and the overview of completed and planned payroll processes; and
an accounting process component that represents relevant business transactions for valuation and profitability analysis; and
the process component interactions include interactions between:
the payroll processing process component and the accounting process component; and
the payroll processing process component and the employee payroll administration process component; and
using the design including the specified process components and the specified process component interactions to develop a computer software application to perform the set of processes.

20. The method of claim 19, wherein:
the specified process components further include:
a payroll processing at provider process component that handles the execution and monitoring of regular as well as off-cycle payroll processes, including completeness checks of payroll relevant employee data, the payroll run itself, verification of the results, and the transfer to financial accounting; and
the process component interactions further include interactions between:
the payroll processing process component and the payroll processing at provider process component related to Italy employee payroll input;
the payroll processing process component and the payroll processing at provider process component related to payroll processing and results;
the payroll processing process component and the payroll processing at provider process component related to South Africa employee payroll input;
the payroll processing process component and the payroll processing at provider process component related to Germany employee payroll input;
the payroll processing process component and the payroll processing at provider process component related to Denmark employee payroll input;
the payroll processing process component and the payroll processing at provider process component related to a payroll process;
the payroll processing process component and the payroll processing at provider process component related to Singapore employee payroll input;
the payroll processing process component and the payroll processing at provider process component related to Netherlands employee payroll input;
the payroll processing process component and the payroll processing at provider process component related to China employee payroll input;
the payroll processing process component and the payroll processing at provider process component related to Australia employee payroll input;
the payroll processing process component and the payroll processing at provider process component related to Canada employee payroll input;
the payroll processing process component and the payroll processing at provider process component related to United States employee payroll input;
the payroll processing process component and the payroll processing at provider process component related to Great Britain employee payroll input; and
the payroll processing process component and the payroll processing at provider process component related to France employee payroll input.

21. The method of claim 19, wherein each process in the set of processes is a business process transforming a defined business input into a defined business outcome.

22. The method of claim 21, wherein obtaining digital data representing the architectural design further comprises editing the design before using the design.
